(19) United States
(12) Patent Application Publication
(10) Pub. No.: US 2007/0021982 A1
(43) Pub. Date: Jan. 25, 2007

(54) Healthcare staffing system

(76) Inventor: Shelly Ann Sun, Lake Forest, IL (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 11/480,290

(22) Filed: Jun. 30, 2006

Related U.S. Application Data
(60) Provisional application No. 60/695,898, filed on Jun. 30, 2005.

(51) Int. Cl. G06Q 10/00

(52) U.S. Cl. 705/2

(57) ABSTRACT

The computer-based system of the invention provides sales, recruiting, account management, scheduling, human resources, payroll and billing, accounting, receivables, and system administration functions for the operation of a healthcare staffing and private duty homecare agency. In particular, the system is designed for use in medically licensed healthcare staffing companies and private duty agencies where various levels of caregivers (i.e. nurses, therapists, CNA's, etc.) are at work in various field settings (i.e. hospitals, MD's offices, patient homes, etc.).

### CROSS REFERENCE TO RELATED APPLICATIONS

This application claims the benefit of U.S. Provisional Application No. 60/695,898, filed Jun. 30, 2005, the contents of which are hereby incorporated by reference herein.

### DESCRIPTION OF THE INVENTION

1. Field of the Invention

The invention relates to a system for healthcare staffing, and more particularly to a web-based system that supports various aspects of running a healthcare staffing and private duty homecare agency.

### SUMMARY OF THE INVENTION

The computer-based system of the invention provides sales, recruiting, account management, scheduling, human resources, payroll and billing, accounting, receivables, and system administration functions for the operation of a healthcare staffing and private duty homecare agency. In particular, the system is designed for use in medically licensed healthcare staffing companies and private duty agencies where various levels of caregivers (i.e. nurses, therapists, CNA's, etc.) are at work in various field settings (i.e. hospitals, MD's offices, patient homes, etc.). However, the system described herein is not limited to healthcare applications, but may be applied in other staffing settings. In particular, the present invention is also applicable to any business where employees make service calls, such as limo services, cable companies, utility companies, HVAC/plumbing/carpentry services, and sales.

The invention is implementable as a web-based system, allowing for automation of virtually all healthcare staffing and private duty homecare agencies that were previously managed manually using paper files and schedules. In this way, the risk of losing control of staff/client processes is minimized as the business grows. Other benefits of the system include: (1) reduced training time for new office hires (2) expedited recruiting and orientation process for new field staff (3) automated tracking of licensure and expiring requirements (i.e. TB tests, CPR certifications, etc.) for field staff positions (4) integration of 3rd party phone-in software that allows for automated timesheet generating on private duty clients and immediate notification when caregivers have not arrived for scheduled shifts (5) allows for management of staffing functions with significantly smaller office staff than in traditional agencies (6) increased efficiency of sales calls by automatically filling in a schedule around confirmed appointments with other leads in the same geographic area (7) reduced errors in payroll and billing due to automated links of schedule information to payroll, and payroll information to invoicing, with automated feeds to a general ledger (8) enhanced, documentable compliance with HIPAA requirements through elimination of paper files and storage of all personal information (both client and employee) in highly secure online system and (9) allows for higher revenues-to-office staff ratio than traditional agencies. Additional benefits of the system will be evident from the detailed description.

It is to be understood that the descriptions of this invention herein are exemplary and explanatory only and are not restrictive of the invention as claimed.

### BRIEF DESCRIPTION OF THE DRAWINGS

FIG. 1 shows the operating environment of a healthcare staffing system in accordance with one embodiment of the invention.

FIG. 2 shows modules of a healthcare staffing system in accordance with one embodiment of the invention.

FIG. 3 shows sub-modules of an administration module of a healthcare staffing system in accordance with one embodiment of the invention.

FIG. 4 shows sub-modules of a customer module of a healthcare staffing system in accordance with one embodiment of the invention.

FIG. 5 shows sub-modules of an employee module of a healthcare staffing system in accordance with one embodiment of the invention.

FIG. 6 shows sub-modules of a financial module of a healthcare staffing system in accordance with one embodiment of the invention.

FIG. 7 shows sub-modules of a workflow queue module of a healthcare staffing system in accordance with one embodiment of the invention.

FIG. 8 shows an announcement sub-module of a healthcare staffing system in accordance with one embodiment of the invention.

FIG. 9 shows an events sub-module of a healthcare staffing system in accordance with one embodiment of the invention.

FIG. 10 shows a view office locations sub-module of a healthcare staffing system in accordance with one embodiment of the invention.

FIG. 11 shows an employee pay stubs sub-module of a healthcare staffing system in accordance with one embodiment of the invention.

FIG. 12 shows a locked users sub-module of a healthcare staffing system in accordance with one embodiment of the invention.

FIG. 13 shows a job post sub-module of a healthcare staffing system in accordance with one embodiment of the invention.

FIG. 14 shows a user manager sub-module of a healthcare staffing system in accordance with one embodiment of the invention.

FIG. 15 shows an add customer sub-module of a healthcare staffing system in accordance with one embodiment of the invention.

FIG. 16 shows a billing rate management sub-module of a healthcare staffing system in accordance with one embodiment of the invention.

FIG. 17 shows a print labels sub-module of a healthcare staffing system in accordance with one embodiment of the invention.

FIG. 18 shows a customer list sub-module of a healthcare staffing system in accordance with one embodiment of the invention.

FIG. 19 shows a customer evaluations sub-module of a healthcare staffing system in accordance with one embodiment of the invention.

FIG. 20 shows a sales module of a healthcare staffing system in accordance with one embodiment of the invention.

FIG. 21 shows a new master employee list sub-module of a healthcare staffing system in accordance with one embodiment of the invention.

FIG. 22 shows an active employees sub-module of a healthcare staffing system in accordance with one embodiment of the invention.

FIG. 23 shows a pending employment sub-module of a healthcare staffing system in accordance with one embodiment of the invention.

FIG. 24 shows an applicants sub-module of a healthcare staffing system in accordance with one embodiment of the invention.

FIG. 25 shows an inactive employees sub-module of a healthcare staffing system in accordance with one embodiment of the invention.

FIG. 26 shows a non-employable list sub-module of a healthcare staffing system in accordance with one embodiment of the invention.

FIG. 27 shows an insured employees sub-module of a healthcare staffing system in accordance with one embodiment of the invention.

FIG. 28 shows a test scores sub-module of a healthcare staffing system in accordance with one embodiment of the invention.

FIG. 29 shows a pay rate management sub-module of a healthcare staffing system in accordance with one embodiment of the invention.

FIG. 30 shows a tax info sub-module of a healthcare staffing system in accordance with one embodiment of the invention.

FIG. 31 shows a payroll management sub-module of a healthcare staffing system in accordance with one embodiment of the invention.

FIG. 32 shows a Ppid management sub-module of a healthcare staffing system in accordance with one embodiment of the invention.

FIG. 33 shows a payroll processing sub-module of a healthcare staffing system in accordance with one embodiment of the invention.

FIG. 34 shows a staff payroll processing sub-module of a healthcare staffing system in accordance with one embodiment of the invention.

FIG. 35 shows a payroll processing holds sub-module of a healthcare staffing system in accordance with one embodiment of the invention.

FIG. 36 shows a fax cover sheet sub-module of a healthcare staffing system in accordance with one embodiment of the invention.

FIG. 37 shows a new employees sub-module of a healthcare staffing system in accordance with one embodiment of the invention.

FIG. 38 shows an updated employees sub-module of a healthcare staffing system in accordance with one embodiment of the invention.

FIG. 39 shows a billing approval sub-module of a healthcare staffing system in accordance with one embodiment of the invention.

FIG. 40 shows a GP invoice import sub-module of a healthcare staffing system in accordance with one embodiment of the invention.

FIG. 41 shows a CC charger sub-module of a healthcare staffing system in accordance with one embodiment of the invention.

FIG. 42 shows an insurance rates sub-module of a healthcare staffing system in accordance with one embodiment of the invention.

FIG. 43 shows a GL report sub-module of a healthcare staffing system in accordance with one embodiment of the invention.

FIG. 44 shows a WC report sub-module of a healthcare staffing system in accordance with one embodiment of the invention.

FIG. 45 is a block diagram of a computer system.

FIG. 46 shows a recruiting module of a healthcare staffing system according to one embodiment of the invention.

### DESCRIPTION OF THE EMBODIMENTS

Reference will now be made in detail to the present exemplary embodiments of the invention, examples of which are illustrated in the accompanying drawings.

The system of the invention is implemented with the use of computers and/or servers. Preferably, the system employs multiple servers or computers. However, more or fewer servers may be used, as the functionality of each may be subdivided or combined as applicable. In one embodiment, the invention makes use of a Microsoft Windows 2000 Small Business Server, a Microsoft Windows 2003 terminal server, and a Microsoft Windows 2000 Professional desktop, each made by Microsoft Corporation of Redmond Wash. The terminal server provides remote access for users and makes available accounting software, e-mail, and file sharing. The Small Business Server provides services for email, SQL services for the accounting software, and the database and software for the staffing system. The 2000 Professional desktop also runs a third-party phone-in system that allows for automated timesheet generation on private duty clients and immediate notification when caregivers have not arrived for scheduled shifts.

The functionality of the staffing system is provided by executable code that is mounted on computer-readable medium in one or more the aforementioned servers and computers. Preferably, such software is written in Active Server Pages (ASP) scripting language and utilizes Microsoft SQL for database services. The software may be implemented as a web-based program, a stand-alone application, or a combination of both.

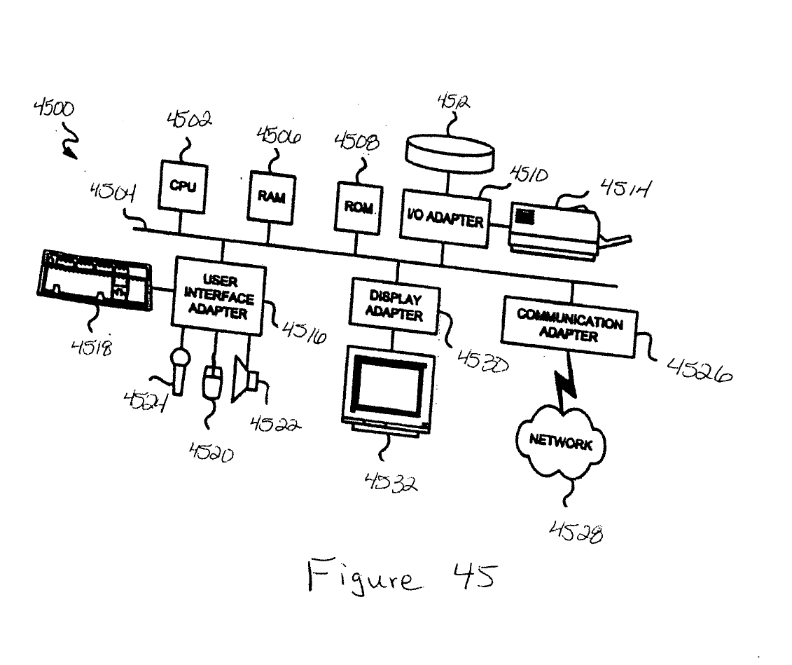

As discussed above, the methods and techniques of the healthcare staffing system of the invention may be implemented in a computer environment, through software programs and/or purpose-built hardware units. FIG. 45 shows an exemplary hardware configuration of a computer system 4500 that may be utilized by the invention. Computer system 4500 has one or more central processing units 4502, such as a microprocessor, and a number of other units interconnected via a system bus 4504.

Computer system 4500 may include a Random Access Memory (RAM) 4506, Read Only Memory (ROM) 4508, and an I/O adapter 4510 for connecting peripheral devices such as, for example, disk storage units 4512 and printers 4514 to the bus 4504. Computer system 4500 also includes a user interface adapter 4516 for connecting various user interface devices such as, for example, a keyboard 4518, a mouse 4520, a speaker 4522, a microphone 4524, and/or other user interface devices such as a touch screen or a digital camera to the bus 4504. Computer system 4500 may further include a communication adapter 4526 for connecting the computer system 4500 to a communication network 4528 (e.g., wireless network, a LAN network, the Internet/WAN, etc.) and a display adapter 4530 for connecting the bus 4504 to a display device 4532.

Computer system 4500 may utilize an operating system such as the Microsoft Windows Operating System (OS), the IBM OS/2 operating system, the MAC OS, the UNIX/Linux operating system, and/or a purpose-built operating system for implementing the Data Security techniques of the invention. Those skilled in the art will appreciate that the present invention may also be implemented on platforms and operating systems other than those mentioned. An embodiment of the present invention may also be written using any programming language, including but not limited to Java, C, and the C++ language and may utilize object oriented programming methodology.

Computer system 4500 may utilize Transmission Control Protocol/Internet Protocol (TCP/IP) as the communication language for accessing the Internet. TCP/IP may also be used as a communications protocol in the private networks called intranet/LAN and in extranet/WAN. TCP/IP is a two-layering program. The higher layer, Transmission Control Protocol (TCP), manages the assembling of a message or file into smaller packets that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination. TCP/IP may use a client/server model of communication in which a computer user (a client) requests and is provided a service (such as sending a Web page) by another computer (a server) in the network. TCP/IP and the higher-level applications that use it may be considered “stateless” because each client request is considered a new request unrelated to any previous one (unlike ordinary phone conversations that require a dedicated connection for the call duration). Being stateless frees network paths so that everyone can use them continuously. Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Computer system 4500 may also utilize wireless connections for communication. Wireless connections may refer to a communications, monitoring, or control system in which electromagnetic radiation spectrum or acoustic waves carry a signal through atmospheric space rather than along a wire. In wireless systems, radio frequency (RF) or infrared transmission (IR) waves may be used. Common examples of wireless equipment in use today include the Global Positioning System (GPS), cellular telephone phones and pagers, cordless computer accessories and wireless LAN (WLAN). Wi-Fi (short for “wireless fidelity”) is a high-frequency wireless local area network (WLAN). Wi-Fi is specified in the 802.11b specification from the Institute of Electrical and Electronics Engineers (IEEE) and is part of a series of wireless specifications together with 802.11 , 802.11a, and 802.11g. All four standards use the Ethernet protocol and CSMA/CA (carrier sense multiple access with collision avoidance) for path sharing.

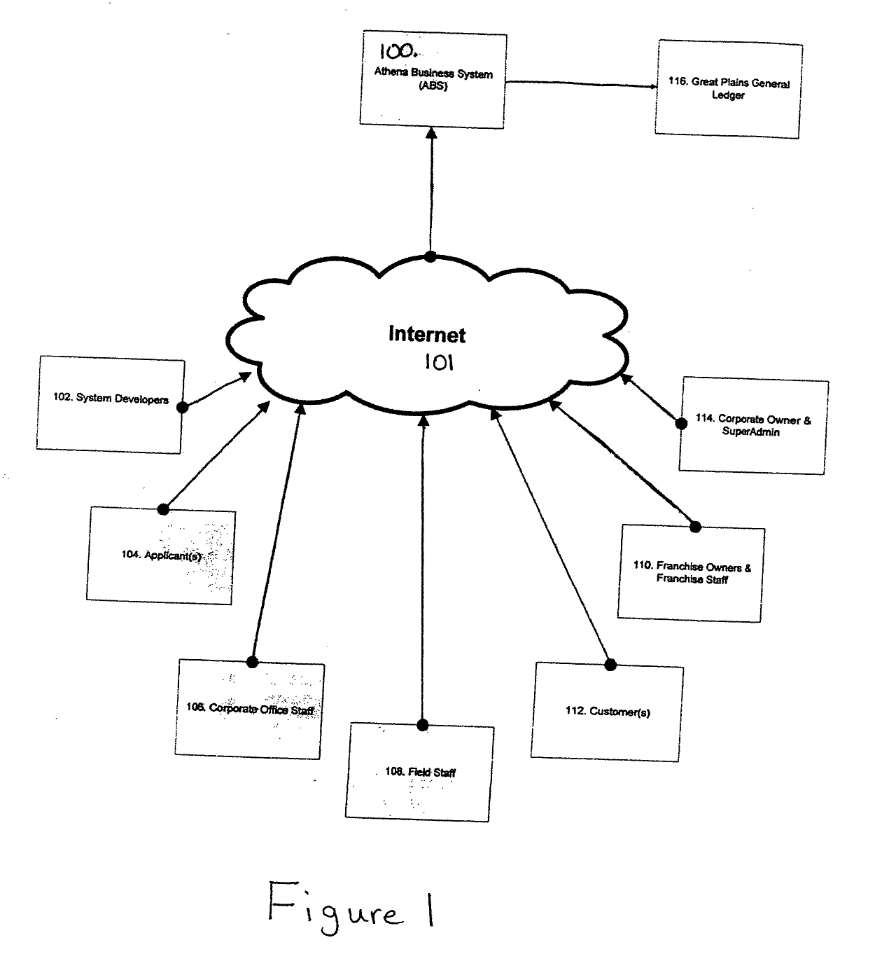

FIG. 1 shows the operating environment of a healthcare staffing system in accordance with one embodiment of the invention. Healthcare staffing system 100 (Athena Business System) may be implemented in a computing environment. As shown in FIG. 1, healthcare staffing system 100 may be connected to other computing devices through a network, such as the Internet. Other computer networking techniques may also be used, including LAN/WAN and wireless. Other computing devices that may connect to the healthcare staffing system 100 including system developers 102 (for updating software), applicant(s) 102, corporate office staff 106, field staff 108, customer(s) 112, franchise owners and franchise staff 110, and corporate owners and administrators 114. In addition, healthcare staffing system 100 may connected to an accounting program 116, such as Great Plains General Ledger from Microsoft Corporation of Redmond, Wash.

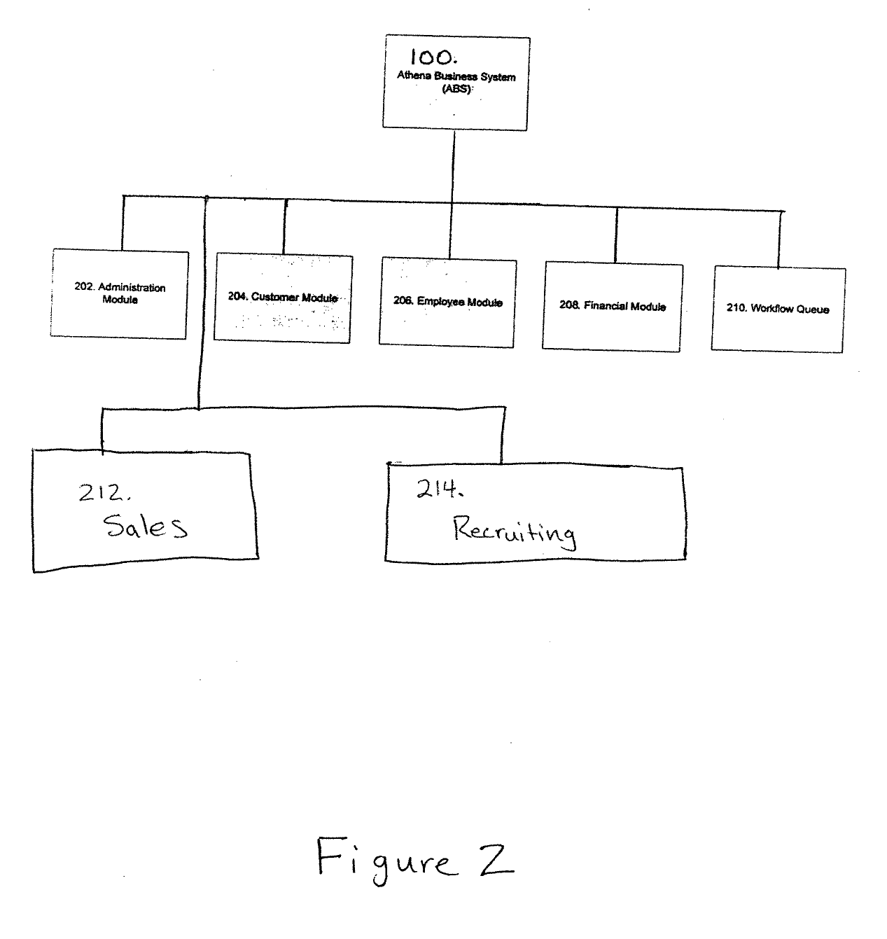

FIG. 2 shows modules of a healthcare staffing system 100 in accordance with one embodiment of the invention. Healthcare staffing system 100 includes an administration module 202, a customer module 204, an employee module 206, a financial module 208, a workflow queue module 210, a sales module 212, and a recruiting module 214.

Administration module 202 supports administrative functions for employees, including corporate announcements, printing pay stubs, and system user management. Administration module 202 also supports the generation of online job postings and newsletters. To support these and other functions, the system keeps centralized storage for all human resource documents including but not limited to: job descriptions, interview guidelines, termination procedures and exit check list, tests and checklist by position type, HIPAA and BBP (blood borne pathogen) training, compliance forms, new hire checklist and orientation materials, etc.

Customer module 204 supports customer-specific functions, including bill rate management, and account setup/maintenance. The customer module may also support tracking of healthcare requests by position type, by state, and expiration dates. The customer module may also trigger a work flow queries item to proactively obtain update CPR, TB, and other licenses. The customer module may also support the ability to load client prospect lists and send periodic communication by client type. The customer module may also generate rate sheets and contracts that are auto populated with client info.

Employee module 206 supports employee-specific functions, including applicant setup/maintenance and pay rate management. The employee module gives employees the ability to apply online, take online tests and continuing education courses, view updated employee handbook, schedules, pay stubs and print timesheets from any internet connection. The employee module automatically monitors turnover. The employee module may include a pricing model tool to ensure bill rate meets minimum margin criteria. The employee module may include the ability to set bill rate and pay rate variances to a set amount per hour by position type and route these billing rates for pre-approval.

Financial module 208 supports financial functions, including payroll, billing, financial reconciliations, insurance management, and interfacing with external accounting programs, such as Great Plains General Ledger 116 (see FIG. 1). The financial module may generate weekly review reports of hours billed by location, if revenue and gross profit by client and position type, as well as key business drivers such as interviews, recruiting calls, time to fill, and percentage conversion. The financial module may also include a cash flow projection tool. The financial module may also generate a paid vs. billed hourly weekly audit report. The financial module may also automatically feed worker's compensation and professional/general liability insurance expenses occurred during a payroll period to an accounting program. In addition, all payroll and billing batches may be automatically fed to an accounting program. The financial module may also support vacation balance tracking. The financial module may also include a client visit calculator that automatically quotes the client a rate based upon mileage from office to client and based upon drive time. The financial module may also support royalty billing to franchisees based upon breakdown of business between local, national contract or VA.

Workflow queue module 21 supports key office personnel (i.e., Branch Manager, Staffing Coordinator, Sales Director, etc.) in managing day-to-day workflows and tasks. This module may include scripting for key customer and employee interactions (i.e., New Job Orders, New Applicant, etc.).

Sales module 212 assists users in managing all functions of the sales process including lead generation, contact maintenance, scheduling and tracking follow-up. Scheduling of client type, department and shift populates accurate pay rate per employee (clock of start time and top time to prevent input errors on proper shift and automatically handles split shift) and bill rate per client. Scheduling is automated to select employees available to work and for the desired shift. In this way, the scheduling process is efficient and most shifts are filled with less than three calls. The sales module may also support sales system tracking of all activity by prospect. In addition, new client set-up automated by selecting “convert to customer” from the prospect screen so all history of a former sales prospect is maintained. The sales module may also support sales commission tracking by zip code as well as by specific clients.

Recruiting module 214 assists users in managing all functions of the recruiting process including lead generation, contact maintenance, scheduling and tracking follow-up. The recruiting module also supports the ability to load recruiting prospect lists and send periodic communication by position type. The recruiting module may also include a recruiting database to house employee prospects before they apply and give users the ability to load resumes, track activity, send automated correspondence by postcard or letter and to convert applicant information.

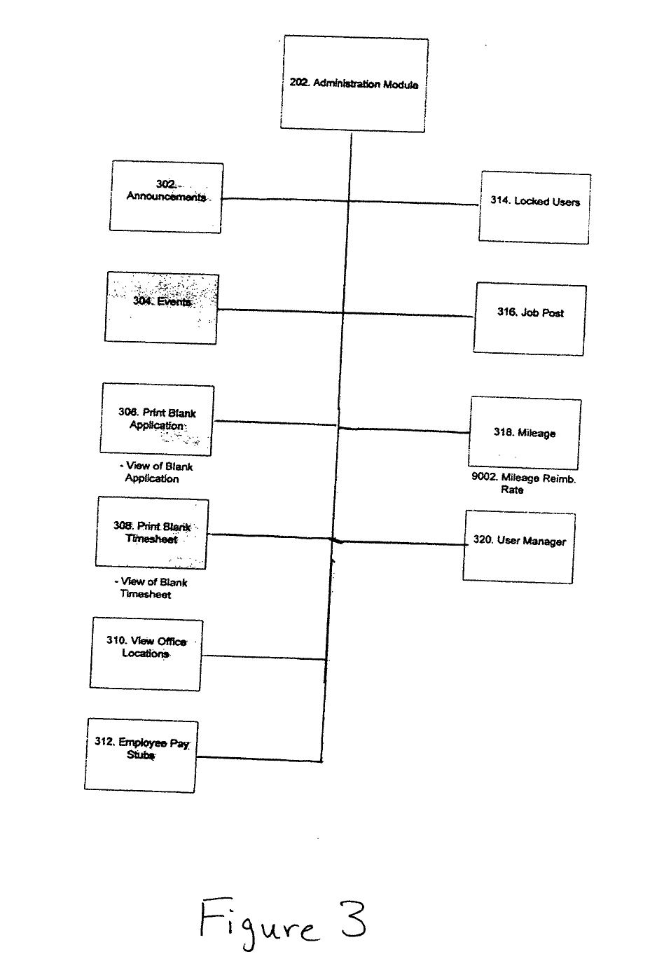

FIG. 3 shows sub-modules of an administration module 202 of a healthcare staffing system in accordance with one embodiment of the invention. Administration module 202 supports administrative functions for employees, including corporate announcements, printing pay stubs, and system user management. Administration module 202 includes announcements sub-module 302, events sub-module 304, print blank application sub-module 306, print blank timesheet sub-module 308, view office locations sub-module 310, employee pay stubs sub-module 312, locked users sub-module 314, job post sub-module 316, mileage sub-module 318, and user manager sub-module 320. Announcements sub-module 302 displays company-wide announcements on the main page of the system to support communication with field staff. Events sub-module 304 communicates (through postings on the main page, e-mail, etc.) key invents involving some/all members of the corporate, franchise, and/or field staff. Print blank applications sub-module 306 allows prospective employees and office staff to print blank employment applications to completed manually (as opposed to online completion). Print blank timesheet sub-module 308 allows field staff to print timesheets that can then be manually completed and signed by a client. View office locations sub-module 301 allows system users to view a list of all active office locations. This sub-module allows a corporate system administrator (SuperAdmin) to add new locations to the system. Employee pay stubs sub-module 312 allows field staff to view files (e.g., a .pdf file) of their weekly paycheck stubs. This sub-module also allows office staff to select an employee/pay period and view paycheck stubs. Locked users sub-module 314 allows the SuperAdmin to view all users (employees) that have been locked out of the system and restore access to specific users. Job post sub-module 316 allows office staff to post online job descriptions (e.g., ‘help wanted’ ads) for positions available by location. Mileage sub-module 318 allows the SuperAdmin to input a standard mileage reimbursement rate 9002 used in payroll and billing functionality. Reimbursement rate 9002 is the per mile rate of reimbursement for mileage and is updated annually based on the IRS rate. User manager sub-module 320 allows the SuperAdmin to add/delete system users, inactivate (lock) user access, change passwords, etc.

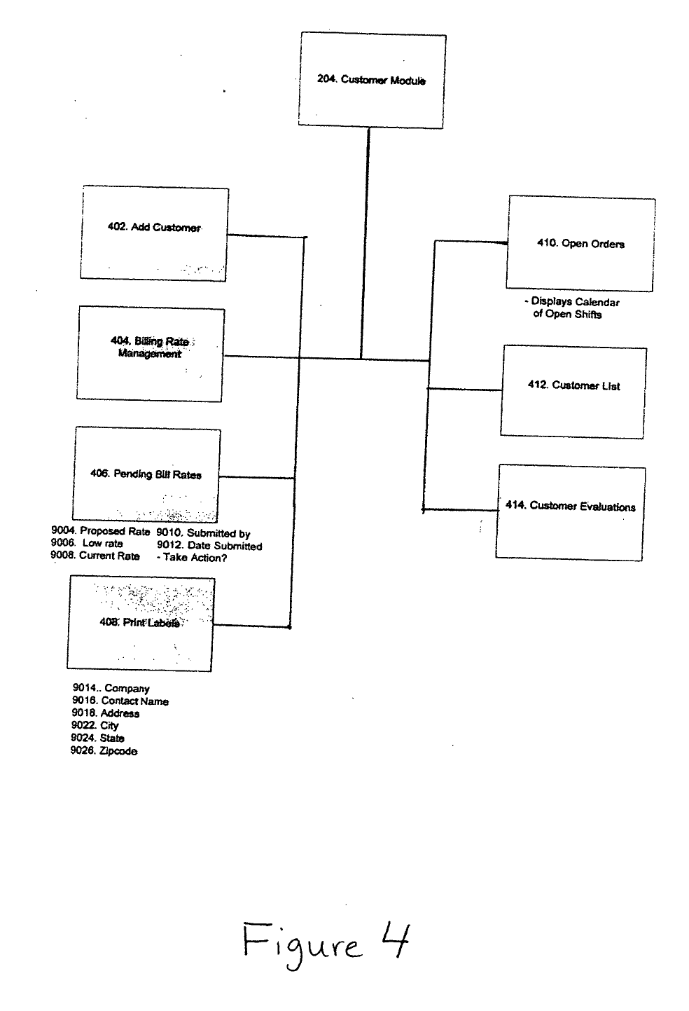

FIG. 4 shows sub-modules of customer module 204 of a healthcare staffing system in accordance with one embodiment of the invention. Customer module 204 supports customer-specific functions, including sales, scheduling, bill rate management, and account setup/maintenance. Customer module 204 includes add customer sub-module 402, billing rate management sub-module 404, pending bill rates sub-module 406, print labels sub-module 408, open orders sub-module 410, customer list sub-module 412, and customer evaluations sub-module 414. Add customer sub-module 402 allows users to set up new customers and input any required/desired information. Billing rate management sub-module 404 allows users to set up and modify both general and customer-specific billing rates by location and position. Pending bill rates sub-module 406 allows users to view all non-standard bill rates requiring FO/SA (franchise owner or SuperAdmin) to approve or reject the rate. Information available to the approver may include proposed rate 9004, low rate 9006 (i.e., the minimum standard rate for the customer/position combination), current rate 9008 (i.e., the preferred billing rate for the customer/position combination), submitter 9010, and date submitted 9012. Print labels sub-module 408 allows users to print mailing labels for all customers for whom invoices have been generated. Information printed on the labels may include company 9014, contact name 9016, address 9018, city 9022, state 9024, and zip code 9026. Open orders sub-module 410 allows users to view a calendar of open shifts that are available for scheduling. Customer list sub-module 412 allows user to look up and access customer information (i.e., schedules, billing information, contact information, etc.) within the system. Customer evaluations sub-module 414 allows users to view outstanding and completed customer evaluations and allows users to set up a new customer evaluation form.

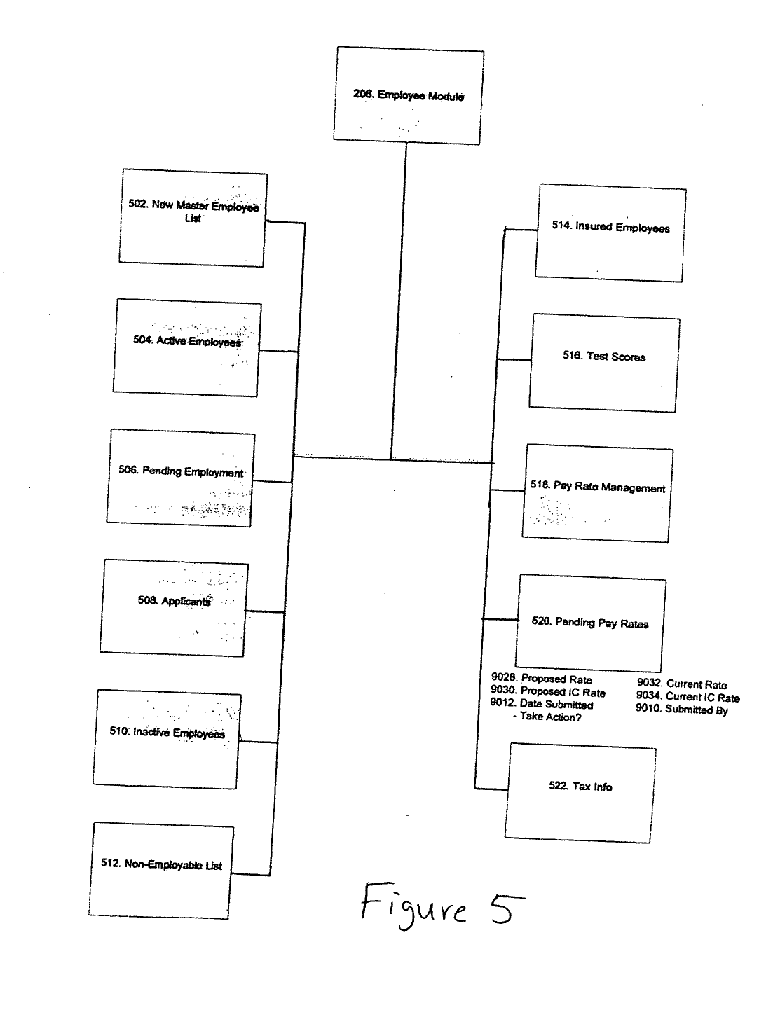

FIG. 5 shows sub-modules of an employee module of a healthcare staffing system in accordance with one embodiment of the invention. Employee module 206 supports employee-specific functions, including applicant setup/maintenance and pay rate management. Employee module 206 includes master employee list sub-module 502, active employees sub-module 504, pending employment sub-module 506, applicants sub-module 508, inactive employees sub-module 510, non-employable list sub-module 512, insured employees sub-module 514, test scores sub-module 516, pay rate management sub-module 518, pending pay rates sub-module 520, and tax info sub-module 522. Master employee list sub-module 502 is an employee search function that allows office staff to search for employees by name, employee status, and/or position type. Active employees sub-module 504 allows office staff to search profiles for all employees with a status of “Active.” Pending employment sub-module 506 allows office staff to search profiles for all employees with a status of “Pending.” Applicants sub-module 508 allows office staff to search profiles for all employees with a status of “Applicant.” Inactive employees sub-module 510 allows office staff to search profiles for all employees with a status of “Inactive.” Non-employable list sub-module 512 allows office staff to search profiles for all employees with a status of “Unemployable.” Insured employees sub-module 514 allows users to view and update all employees who have elected insurance coverage. Test scores sub-module 516 allows user to view test scores for all applicable employees. Pay rate management sub-module 518 allows users to set up and modify both general and employee-specific pay rates by location and position. Pending pay rates sub-module 520 allows users to view all non-standard pay rates that may require FO/SA approval prior to implementation. The information displayed by this screen may include proposed rate 9028, proposed independent contractor (IC) rate 9030, current rate 9030 (i.e., preferred rate for customer/employee combination), current IC rate 9034 (i.e., preferred rate for customer/independent contractor combination), submitter 9010, and date submitted 9012. This sub-module may also allow a FO/SA to approve or reject the pending pay rate. Tax info sub-module 522 allows users to input federal, state, and local tax information, direct deposit information, and personal information related to hiring and termination dates for employees.

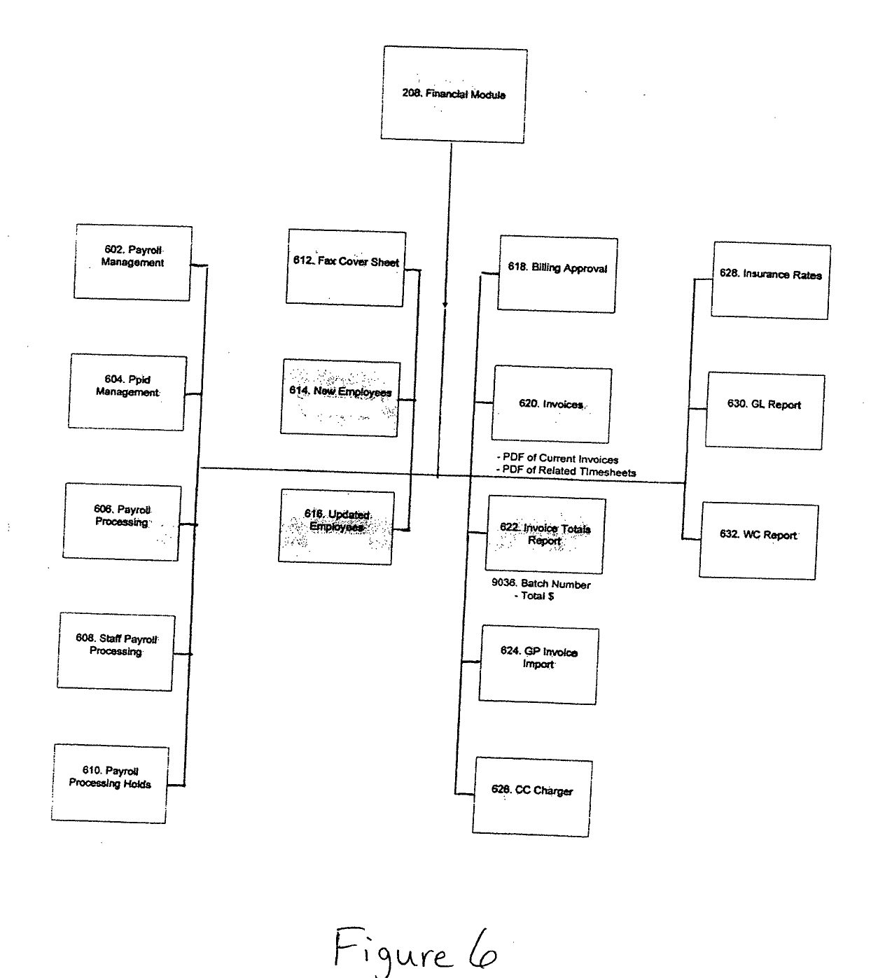

FIG. 6 shows sub-modules of a financial module of a healthcare staffing system in accordance with one embodiment of the invention. Financial module 208 supports financial functions, including payroll, billing, financial reconciliations, insurance management, and interfacing with external accounting programs, such as Great Plains General Ledger 116 (see FIG. 1). Financial module 208 includes payroll management sub-module 602, Ppid management sub-module 604, payroll processing sub-module 606, staff payroll processing sub-module 608, payroll processing holds sub-module 610, fax cover sheet sub-module 612, new employees sub-module 614, updated employees sub-module 616, billing approval sub-module 618, invoices sub-module 620, invoice totals report sub-module 622, GP Invoice import sub-module 624, credit card charger sub-module 626, insurance rates sub-module 628, GL report sub-module 630, and WC report sub-module 632. Payroll management sub-module 602 generates payroll-related reports. Ppid (payroll period id) management sub-module 604 locks and unlocks payroll for a given payroll period. Payroll processing sub-module 606 processes weekly timesheets and payroll for all field employees. Staff payroll processing sub-module 608 processes weekly payroll for office staff. Payroll processing holds sub-module 610 processes prior period payroll amounts placed on hold due to lack of timesheets or other supporting documentations. Fax cover sheet sub-module 612 generates pre-formatted cover sheet forms for faxing payroll to payroll processing. New employees sub-module 614 generates a summary page detailing payroll-related information (i.e., social security number, tax filing statuses, direct deposition information, etc.) for new employees. This information may be faxed to payroll processing with payroll. Updated employees sub-module 616 generates a summary page detailing changes to payroll-related information (i.e., social security number, tax filing statuses, direct deposition information, etc.) for existing employees. This information may be faxed to payroll processing with payroll. Billing approval sub-module 618 allows users to review, revise, and approve weekly invoices. Invoices sub-module 620 allows users to view all invoices with related timesheets for a selected customer and/or invoice date. Invoice totals report sub-module 622 allows users to view totals for each week's invoices in one summary. This sub-module may use batch number 9036 to select specific batch entries in the external accounting program, such as Great Plains General Ledger 116. GP invoice import sub-module 624 allows users to import prior period's invoice back from an external accounting program. Users many then adjust invoices as necessary and resubmit them to the external accounting program. Credit card charger sub-module 626 charges credit cards for services and associate payment with a specific customer/invoice number. Insurance rates sub-module 628 allows users to view and update health insurance rates by plan type and coverage type for field and office staff. GL report sub-module 630 allows users to detail supporting monthly GL (general liability) insurance expenses by account and submits ajournal entry to an external accounting program. WC report sub-module 632 allows users to view detail supporting monthly WC (worker's compensation) insurance expenses by account and submits ajournal entry to an external accounting program.

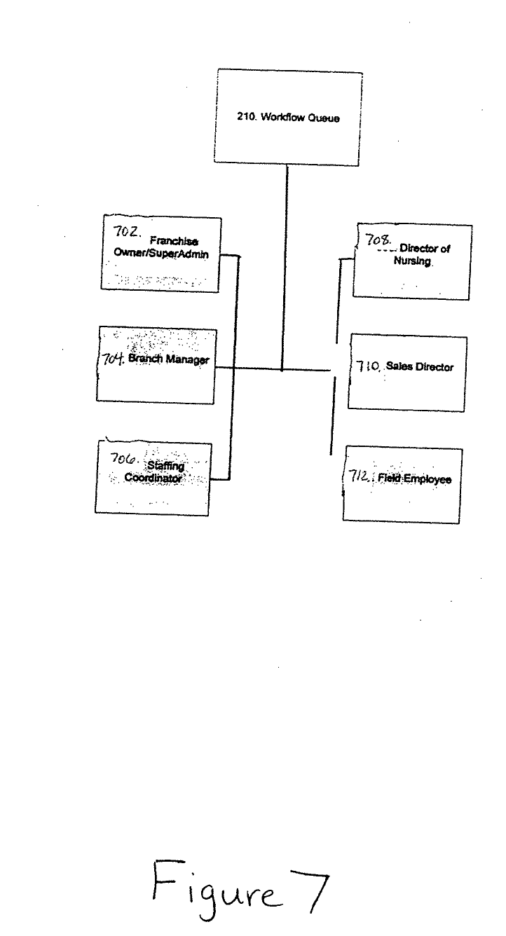

FIG. 7 shows sub-modules of a workflow queue module of a healthcare staffing system in accordance with one embodiment of the invention. Workflow queue module 21 supports key office personnel (i.e., Branch Manager, Staffing Coordinator, Sales Director, etc.) in managing day-to-day workflows and tasks. This module may include scripting for key customer and employee interactions (i.e., New Job Orders, New Applicant, etc.). Workflow queue module 210 includes franchise owner/SuperAdmin sub-module 702, branch manager sub-module 704, staffing coordinator sub-module 706, director of nursing sub-module 708, sales director sub-module 710, and field employee sub-module 712. Franchise owner/SuperAdmin sub-module 702 contains task directions for franchise owners and/or SuperAdmins at specific locations. The direction may be for specific task and/or reminders for routine activities. The directions and task are auto-generated by the sub-module based on both calendar and event driven logic. Branch manger sub-module 704 contains task directions for branch managers at specific locations. The direction may be for specific task and/or reminders for routine activities. The directions and task are auto-generated by the sub-module based on both calendar and event driven logic. Staffing coordinator sub-module 706 contains task directions for staffing coordinators at specific locations. The direction may be for specific task and/or reminders for routine activities. The directions and task are auto-generated by the sub-module based on both calendar and event driven logic. Director of nursing sub-module 708 contains task directions for directors of nursing at specific locations. The direction may be for specific task and/or reminders for routine activities. The directions and task are auto-generated by the sub-module based on both calendar and event driven logic. Sales director sub-module 710 contains task directions for sales directors at specific locations. The direction may be for specific task and/or reminders for routine activities. The directions and task are auto-generated by the sub-module based on both calendar and event driven logic. Field employees sub-module 712 contains task directions for field employees at specific locations. The direction may be for specific task and/or reminders for routine activities. The directions and task are auto-generated by the sub-module based on both calendar and event driven logic.

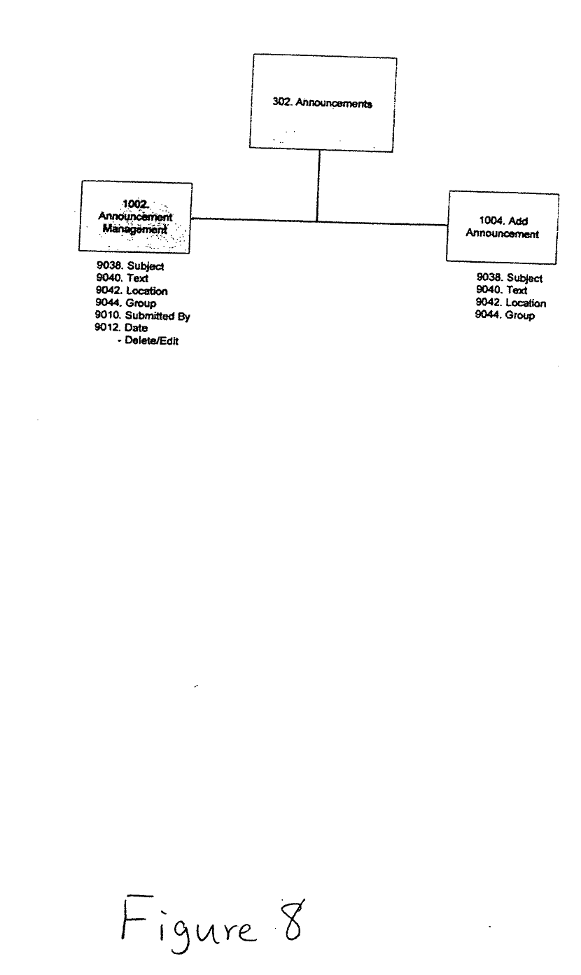

FIG. 8 shows announcement sub-module 302 of a healthcare staffing system in accordance with one embodiment of the invention. Announcements sub-module 302 displays company-wide announcements on the main page of the system to support communication with field staff. Announcements sub-module 302 includes announcement management sub-module 1002 and add announcement sub-module 1004. Announcement management sub-module 1002 allows users to view, edit or delete active announcement posted on the main page of the healthcare staffing system (such as on the website). Announcements may include a subject field 9038, a text field 9040, a location field 9042 (e.g., corporate or franchise office), a groups field 9044 (identifies groups of employees associated with the announcement), submitter field 9010, and date field 9012. Add announcement sub-module 1004 allows users to create new announcements to be posted on the main page of the healthcare staffing system (such as on the website).

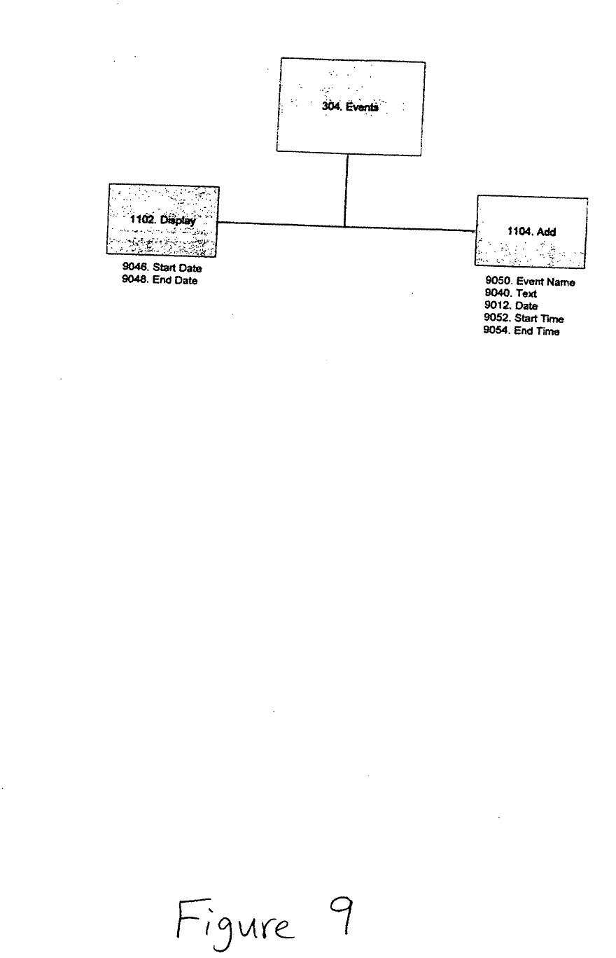

FIG. 9 shows events sub-module 304 of a healthcare staffing system in accordance with one embodiment of the invention. Events sub-module 304 communicates (through postings on the main page, e-mail, etc.) key invents involving some/all members of the corporate, franchise, and/or field staff. Events sub-module 304 includes display events sub-module 1102 and add event sub-module 1104. Display events sub-module 1102 allows users to enter a start date 9046 and an end date 9048 and then display all listed events within that date range. Add event sub-module 1104 allows users to add a new event to the calendar. New event information may include event name field 9050, text field 9040, date field 9012, start time 9052, and end time 9054.

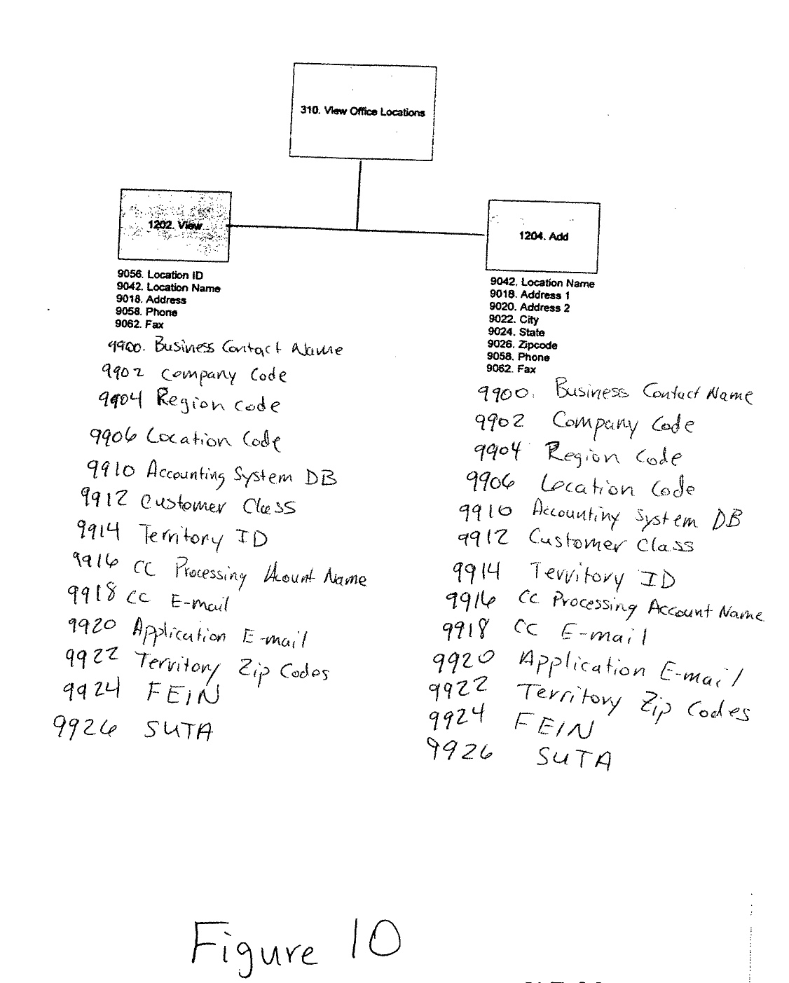

FIG. 10 shows view office locations 310 sub-module of a healthcare staffing system in accordance with one embodiment of the invention. View office locations sub-module 301 allows system users to view a list of all active office locations. This sub-module also allows a corporate system administrator (SuperAdmin) to add new locations to the system. View office location sub-module 310 includes a view office locations sub-module 1202 and add office location sub-module 1204. View office locations sub-module 1202 allows users to view all office locations including the location ID number 9056, location name 9042, address 9018, phone number 9058, fax number 9062 of the location, business contract name 9900, company code 9902, region code 9904, location code 9906, accounting system database 9910, customer class 9912, territory ID 9914, credit card processing account name 9916, credit card receipt email address 9918, application email address 9920, territory zip codes 9922, FEIN (Federal Employment Identification Number) 9924, and SUTA (State Unemployment Tax) number 9926. Add office location 1204 allows the SuperAdmin to add a new location. New location information may include location name 9042, address 1 9018, address 2 9020, city 9022, state 9024, zip code 9026, phone number 9058, fax number 9062, business contract name 9900, company code 9902, region code 9904, location code 9906, accounting system database 9910, customer class 9912, territory ID 9914, credit card processing account name 9916, credit card receipt email address 9918, application email address 9920, territory zip codes 9922, FEIN (Federal Employment Identification Number) 9924, and SUTA (State Unemployment Tax) number 9926.

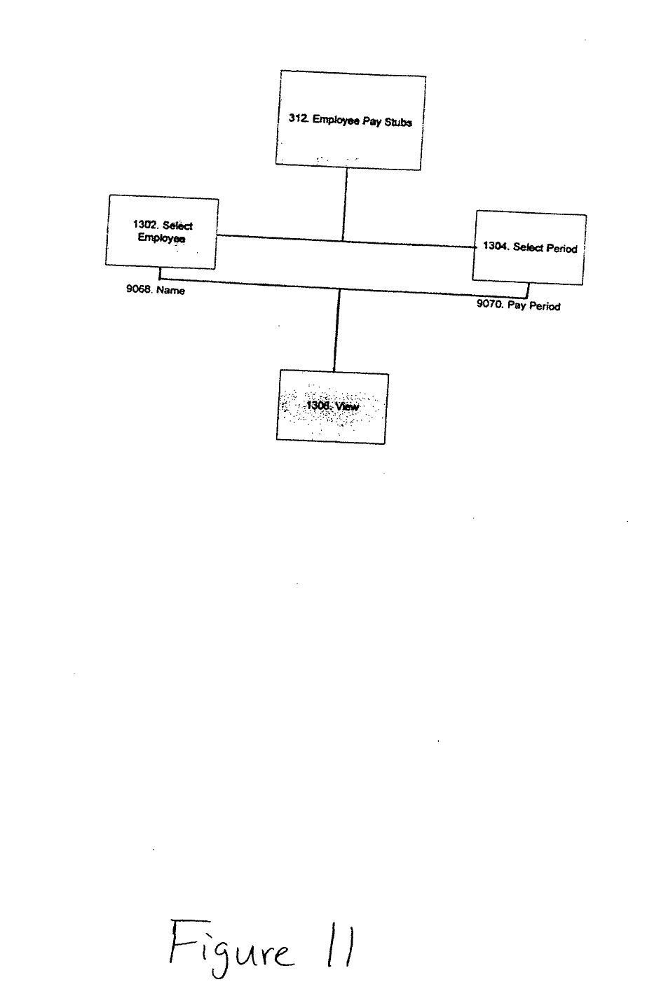

FIG. 11 shows employee pay stubs sub-module 312 of a healthcare staffing system in accordance with one embodiment of the invention. Employee pay stubs sub-module 312 allows field staff to view files (e.g., a .pdf file) of their weekly paycheck stubs. This sub-module also allows office staff to select an employee/pay period and view paycheck stubs. Employee pay stubs sub-module 312 includes select employee sub-module 1302, select period sub-module 1304, and view sub-module 1306. Select employee sub-module 1302 allows users to select the employee for which they would like to view a pay stub. Employees are selected by name in name field 9068. Select period sub-module 1304 allows users to select the pay period for which they would like to view a pay stub. Pay periods are stored in pay period field 9070. View sub-module 1306 generates a .html file of the selected pay stub.

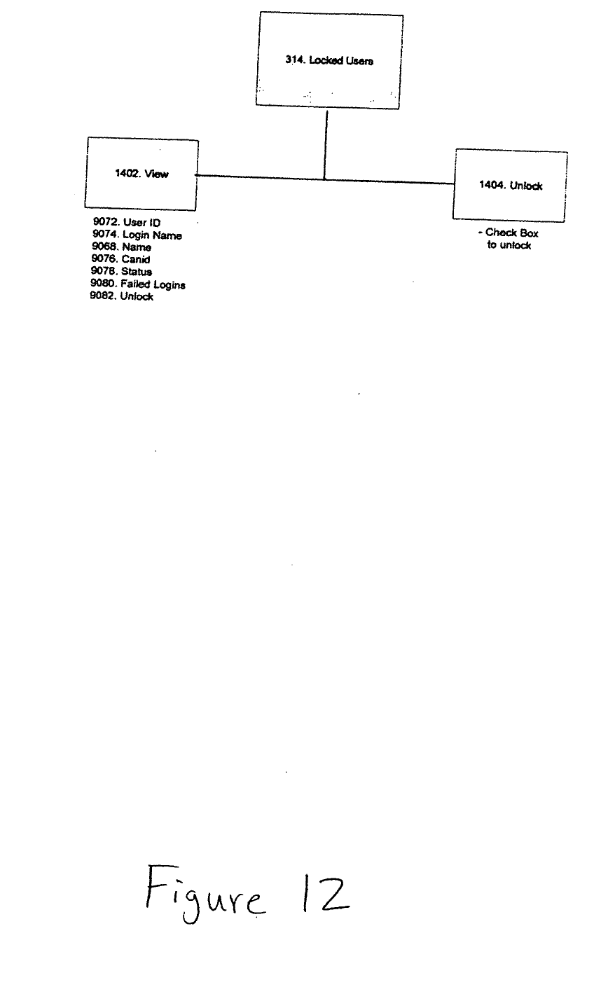

FIG. 12 shows locked users sub-module 314 of a healthcare staffing system in accordance with one embodiment of the invention. Locked users sub-module 314 allows the SuperAdmin to view all users (employees) that have been locked out of the system and restore access to specific users. Locked users sub-module 314 includes view sub-module 1402 and unlock sub-module 1404. View sub-module 1402 allows users to view all users whose access to the system has been locked. The information displayed may include user ID 9072, login name 9074, name 9068, canid 9076 (user's system identification), status 9078 (i.e., Active, Inactive, Pending, etc.), failed logins 9080, and unlock request 9082. Unlock sub-module 1404 allows a user to restore (i.e., unlock) a user's access to the system. Preferably, a user's access is unlocked by selecting an indicia (e.g., a checkbox) next the display of unlock request 9082.

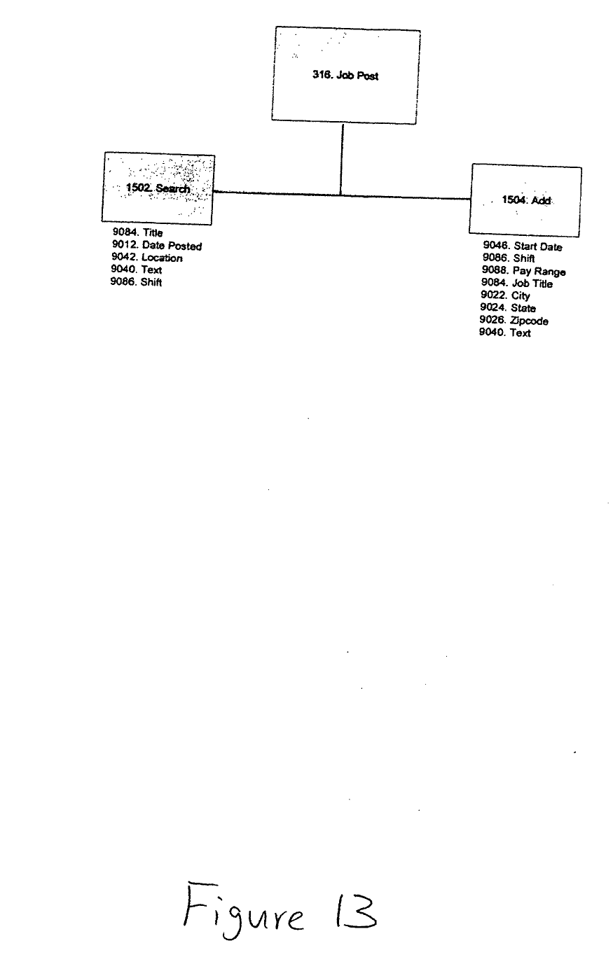

FIG. 13 shows job post sub-module 316 of a healthcare staffing system in accordance with one embodiment of the invention. Job post sub-module 316 allows office staff to post online job descriptions (e.g., ‘help wanted’ ads) for positions available by location. Job post sub-module 316 includes search sub-module 1502 and add sub-module 1504. Search sub-module 1502 allows users to search for an existing job posting. The job posting may be searched based on title 9084, date pasted 9012, location 9042, text field 9040, or shift 9086. Add sub-module 1504 allows users to add a job posting to the system. The added job posting may include the start date 9046, shift 9086, pay range 9088, job title 9084, city 9022, state 9024, zip code 9026, and a text description 9040.

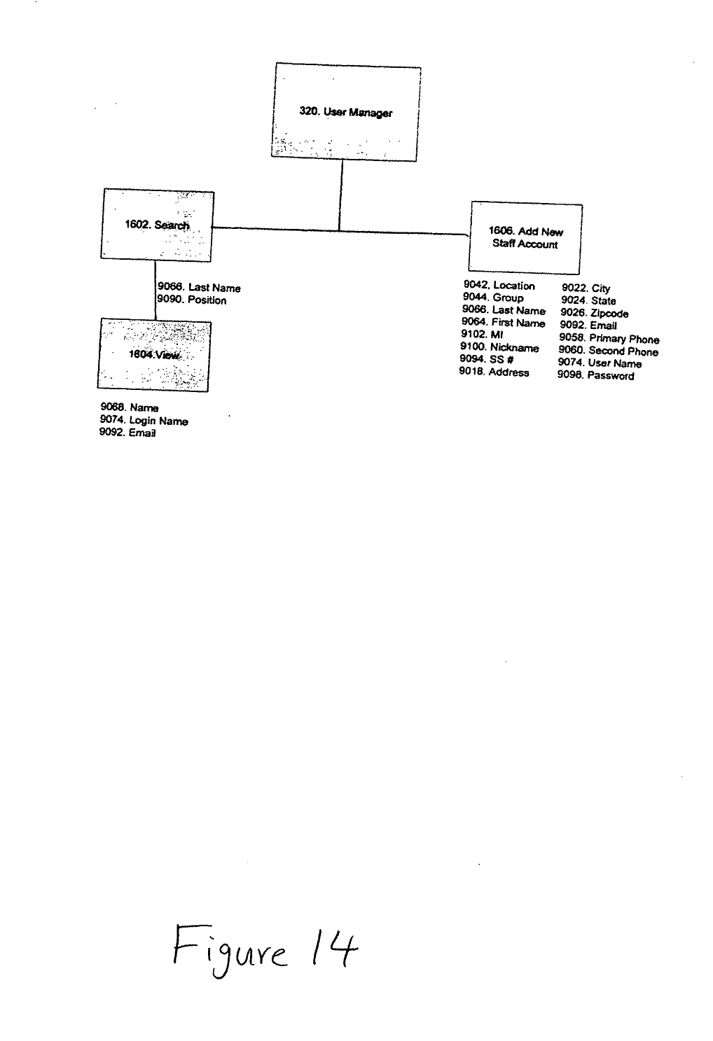

FIG. 14 shows user manager sub-module 320 of a healthcare staffing system in accordance with one embodiment of the invention. User manager sub-module 320 allows the SuperAdmin to add/delete system users, inactivate (lock) user access, change passwords, etc. User manager sub-module 320 includes search sub-module 1602, view sub-module 1604, and add new staff account sub-module 1606. Search sub-module 1602 allows users to search for a specific user by last name 9066 and/or by position 9090. View sub-module 1604 allows the user to view details for the selected user including name 9068, login name 9074, and email address 9092. Add new staff account sub-module 1606 allows the SuperAdmin to setup a new employee in the system. New employee information entered in the setup may include location 9042, group 9044 (i.e., employee, office staff, franchise staff, etc.), last name 9066, first name 9064, middle initial 9102, nickname 9100, social security number 9094, address 9018, city 9022, state 9024, zip code 9026, email address 9092, primary phone number 9058, secondary phone number 9060, user name 9074, and password 9098.

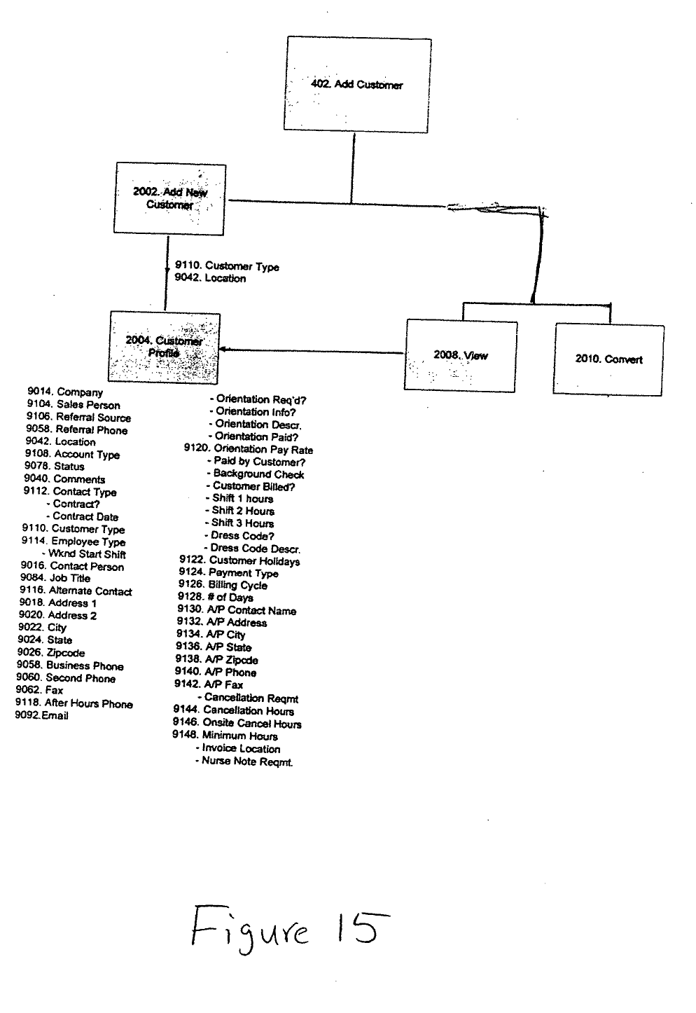

FIG. 15 shows add customer sub-module 402 of a healthcare staffing system in accordance with one embodiment of the invention. Add customer sub-module 402 allows users to set up new customers and input any required/desired information. Add customer sub-module 402 includes add new customer sub-module 2002, customer profile sub-module 2004, view sub-module 2008, and convert sub-module 2010. Add new customer sub-module 2002 allows users to specify a customer type 9110 and location 9042 for the customer being added. Customer type 9110 indicates the setting for the employment which may include hospitals, MD's office, private patients, etc. Customer profile sub-module 2004 allows users to input detailed account information for new customers. The account information may include company 9014, sales person 9104, referral source 9106, referral phone number 9058, location 9042, account type 9108 (local, regional, national, governmental), status 9078 (Active, Inactive, Pending, etc.), comments 9040, contact type 9112 (current customer or sales prospect), customer type 9110, employee type 9114 (RN, LPN, CNA, etc.), contact person 9016, job title 9084, alternate contact 9116, address 1 9018, address 2 9020, city 9022, state 9024, zip code 9026, business phone 9058, secondary phone 9060, fax number 9062, after hours phone 9118, email address 9092, orientation pay rate 9120 (pay rate for employees during orientation for the customer), customer holidays 9122, payment type 9124 (cash, check, credit card), billing cycle 9126, number of days 9128 (for non-standard billing cycle), accounts payable (A/P) contact name 9130, A/P address 9132, A/P city 9134, A/P state 9136, A/P zip code 9138, A/P phone number 9140, A/P fax number 9142, cancellation hours 9144 (hours of notice required for canceling a shift); onsite cancel hours 9146 (number of hours billed to customer if shift canceled while employee is onsite), and minimum hours 9148 (minimum number of hours an employee will work). The account information may include additional information describing the customer including whether an orientation is required, orientation information, orientation description, if orientation time is paid, if orientation is paid by the customer, if background checks are required, how the customer is to be billed, shift 1 hours, shift 2 hours, shift 3 hours, if there is a dress code, and dress code requirement. View sub-module 2008 allows users to view a profile for a specific customer. The information displayed is the account information entered with customer profile sub-module 2004. Convert sub-module 2010 automatically changes the status of a sales prospect to an active customer when the sales prospect is entered as a new customer.

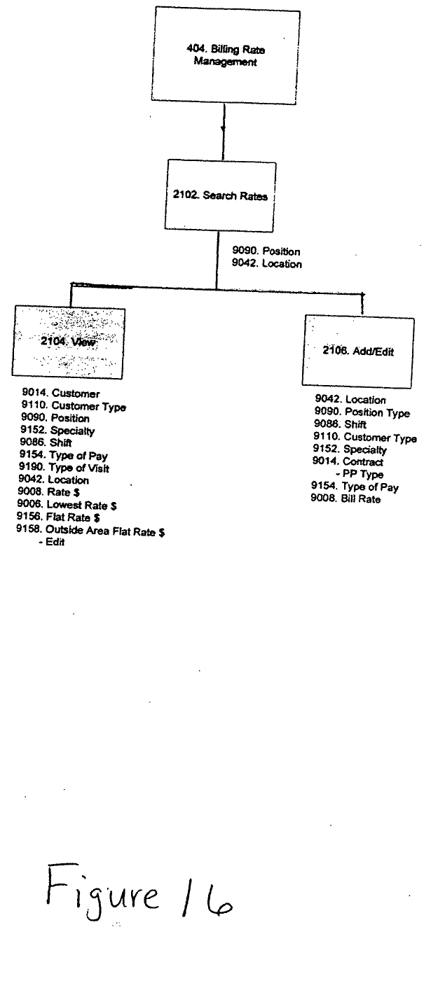

FIG. 16 shows billing rate management sub-module 404 of a healthcare staffing system in accordance with one embodiment of the invention. Billing rate management sub-module 404 allows users to set up and modify both general and customer-specific billing rates by location and position. Billing rate management sub-module 404 includes search rates sub-module 2102, view sub-module 2104, and add/edit sub-module 2106. Search rates sub-module 2102 allows users to search existing bill rates by position 9090 and location 9042. View sub-module 2104 allows users to view details for existing bill rates. Details may include customer 9104, customer type 9110, position 9090, specialty 9152 (ICU, orthopedics, pediatrics, etc.), shift 9086, type of pay 9154 (hourly or flat rate), type of visit 9190 (services to be rendered during the visit), location 9042, current bill rate 9008, low bill rate 9006, flat rate 9156, and outside area flat rate 9158. Add/edit sub-module 2106 allows users to add or update existing bill rates. The information that may be added or edited includes location 9042, position type 9090, shift 9086, customer type 9110, specialty 9152, company 9014, type of pay 9154, and current bill rate 9008.

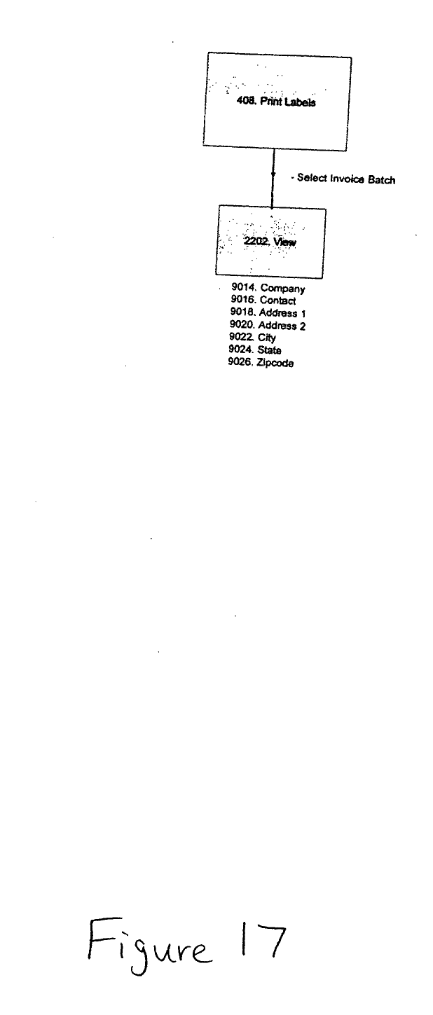

FIG. 17 shows print labels sub-module 408 of a healthcare staffing system in accordance with one embodiment of the invention. Print labels sub-module 408 allows users to print mailing labels for all customers for whom invoices have been generated. Information printed on the labels may include company 9014, contact name 9016, address 9018, city 9022, state 9024, and zip code 9026. Print labels sub-module 408 includes view labels sub-module 2202. View labels sub-module 2202 allows users to view and/or print labels for customers receiving invoices for current week.

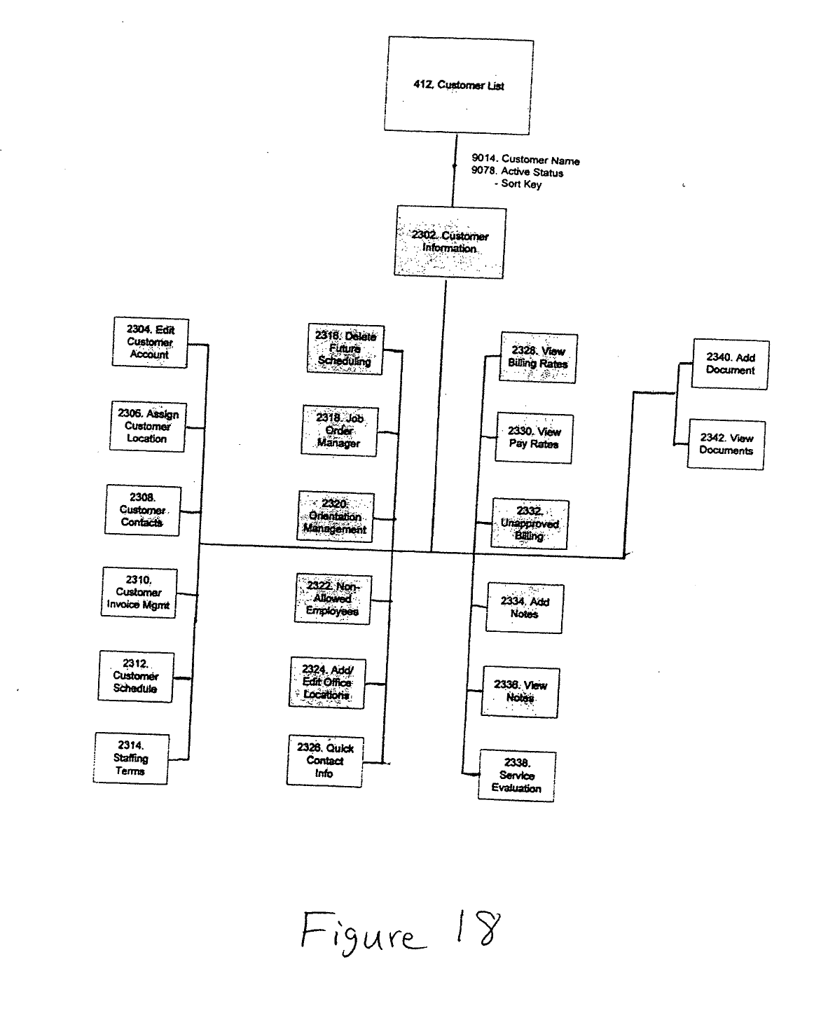

FIG. 18 shows customer list sub-module 412 of a healthcare staffing system in accordance with one embodiment of the invention. Customer list sub-module 412 allows user to look up and access customer information (i.e., schedules, billing information, contact information, etc.) within the system. Customer list sub-module 412 includes customer information sub-module 2302, edit customer account sub-module 2304, assign customer location sub-module 2306, customer contacts sub-module 2308, customer invoice management sub-module 2310, customer schedule sub-module 2312, staffing terms sub-module 2314, delete future scheduling sub-module 2316, job order manager sub-module 2318, orientation management sub-module 2320, non-allowed employees sub-module 2322, add/edit office locations sub-module 2324, quick contact info sub-module 2326, view billing rates sub-module 2328, view pay rates sub-module 2330, unapproved billing sub-module 2332, add notes sub-module 2334, view notes sub-module 2336, service evaluation sub-module 2338, add document sub-module 2340, view documents sub-module 2342. Customer information sub-module 2302 allows access to multiple customer-related functions including editing customer account information, maintaining schedules, creating new job orders, posting notes, etc. Edit customer account sub-module 2304 allows users to update account information for a selected customer. Assign customer location sub-module 2306 allows users to assign a location to a specific customer. Customer contacts sub-module 2308 allows users to update contact people of record for the selected customer. Customer invoice management sub-module 2310 allows users to update information on invoice recipients/mailing addresses. Customer schedule sub-module 2312 allows users to view (e.g., in monthly formats) scheduled shifts for a customer and to add/edit/cancel selected shifts. Staffing terms sub-module 2314 allows users to input terms of staffing contract(s) with the selected customer. Delete future scheduling sub-module 2316 allows users to delete entire customer schedule from a specified data forward. Job order manager sub-module 2318 allows users to view all active jobs for a selected customer and to add/modify chose jobs. Orientation management sub-module 2320 allows users to maintain a list of employees who have completed orientations if required by the customer. Non-allowed employees sub-module 2322 allows users to specify employees that are not allowed to work for a particular customer. Add/edit office locations sub-module 2324 allows users to update sales and servicing locations for selected customers. Quick contact info sub-module 2326 allows users to view primary contact information for customers without scrolling through the entirety of the account information. View billing rates sub-module 2328 allows users to view only bill rates specific to selected customers. View pay rates sub-module 2330 allows users to view only pay rates specific to selected customers. Unapproved billing sub-module 2332 allows users to view all pending billing for a selected customer. Add notes sub-module 2334 allows users to add notes for a customer. View notes sub-module 2336 allows users to view all notes in the system for a specific customer. Service evaluation sub-module 2338 generates an online form that allows a customer to input feedback on services provided. Add document sub-module 2340 allows users to attach a scanned document to a customer's file. View documents sub-module 2342 allows users to view all scanned documents attached to a customer's file.

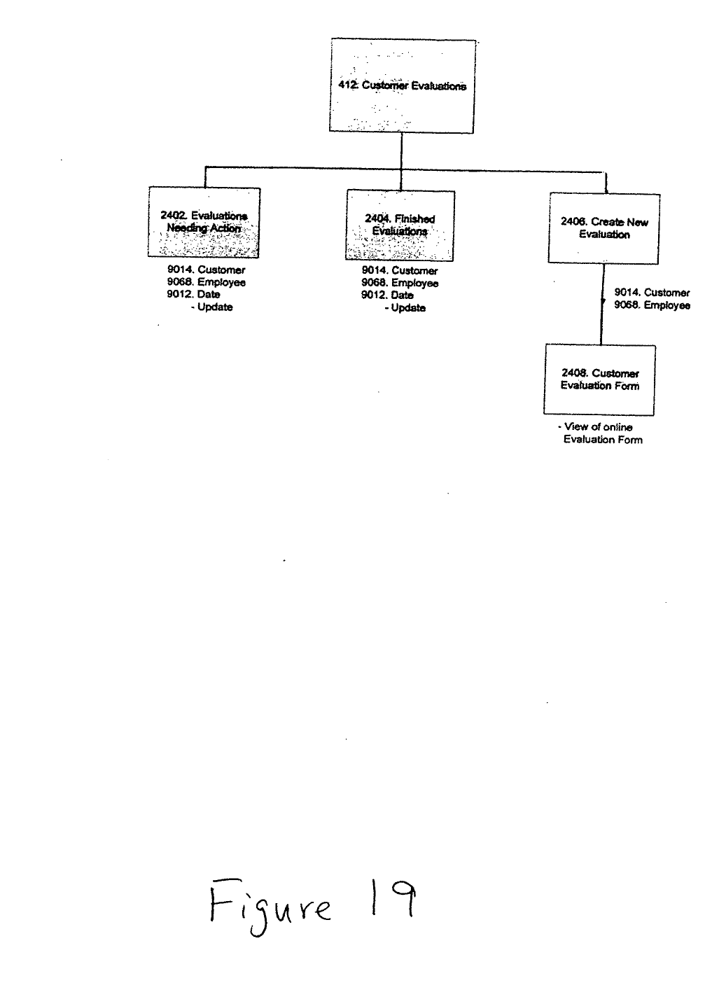

FIG. 19 shows customer evaluations sub-module 414 of a healthcare staffing system in accordance with one embodiment of the invention. Customer evaluations sub-module 414 allows users to view outstanding and completed customer evaluations and allows users to set up a new customer evaluation form. Customer evaluations sub-module 414 includes evaluations needing action sub-module 2402, finished evaluations sub-module 2404, create new evaluation sub-module 2406, and customer evaluation form sub-module 2408. Evaluations needing action sub-module 2402 allows users to view customer evaluations that are in progress. Evaluations in progress are searchable by customer 9014, employee 9068, and date 9012. Finished evaluations sub-module 2404 allows users to view completed customer evaluations. Completed evaluations are searchable by customer 9014, employee 9068, and date 9012. Create new evaluation sub-module 2406 allows users to generate online evaluations specific to a customer 9014/employee 9068 combination. Customer evaluation form sub-module 2408 allows users to view and input data into a customer evaluation form.

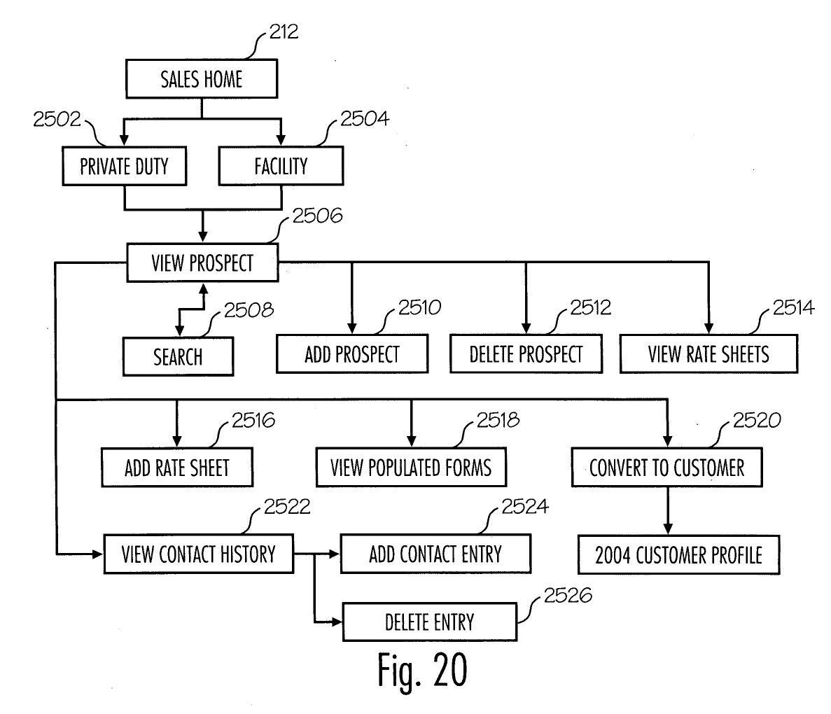

FIG. 20 shows sales system module 212 of a healthcare staffing system in accordance with one embodiment of the invention. Sales module 212 assists users in managing all functions of the sales process including lead generation, contact maintenance, scheduling and tracking follow-up. Sales module 212 includes private duty sub-module 2502, facility sub-module 2504, search sub-module 2508, add prospect sub-module 2510, delete prospect sub-module 2512, view prospect sub-module 2506, view rate sheets sub-module 2514, add rate sheet sub-module 2516, view populated forms sub-module 2518, convert to customer sub-module 2520, view contact history sub-module 2522, add contact entry sub-module 2524, and delete entry sub-module 2526. Private duty sub-module 2502 allows users to access private duty clients'records in the sales system. Facility sub-module 2504 allows users to access facility clients'records in the sales system. Search sub-module 2508 allows users to search for an existing sales contact in order to review or add information. The user may search by any of company, contact name, email address, customer type, address, city, zip code, referral source, location, contact type, contact person, and contact date range. View prospect sub-module 2506 allows users to view or edit prospect information. Information that may be viewed or edited includes company, contact name, contact title, address, city, state, zip, customer type, sales location, phone number, after hours phone number, fax number, email address, web site, additional contacts, referral, quoted bill rate, personal information, education, background, interests, lifestyle, and rate sheets. Add prospect sub-module 2510 allows users to create new sales prospects in the sales system. Information that may be created is the same that may be viewed or edited in view prospect sub-module 2506. Delete prospect sub-module 2512 allows users to delete sales prospects from the system. View rate sheets sub-module 2514 allows users to view and edit rate sheets for a sales prospect. The information that may be viewed and edited includes position type, bill rate, and conversion rate. Add rate sheet sub-module 2516 allows users to create a new rate sheet for the sales prospect. The information that may be added with the new rate sheet includes position type, bill rate, and conversion rate. View forms sub-module 2518 allows users to view documents that auto populate information based on the sales prospect the user is viewing. The information that may be auto populated includes company, contact name, address, city, state, zip, location business name, location address, location city, location state, location zip code, and location FEIN. The documents that may be viewed includes customer service evaluation, corporate client contract, institutional client sales letter, and private duty service agreement. Convert to customer sub-module 2520 allows users to transform a sales prospect record into a customer record in the customer module 204. View contact history sub-module 2522 allows users to review contact or attempted contact between the sales prospect and the user. Information that may be reviewed includes contact date, contact type, next action, and notes. Add contact entry sub-module 2524 allows users to create a new record of contact between the sales prospect and the user. Information that may be recorded includes contact date, contact type, next action, and notes. Delete entry sub-module 2526 allows users to remove a record of contact between the sales prospect and the user.

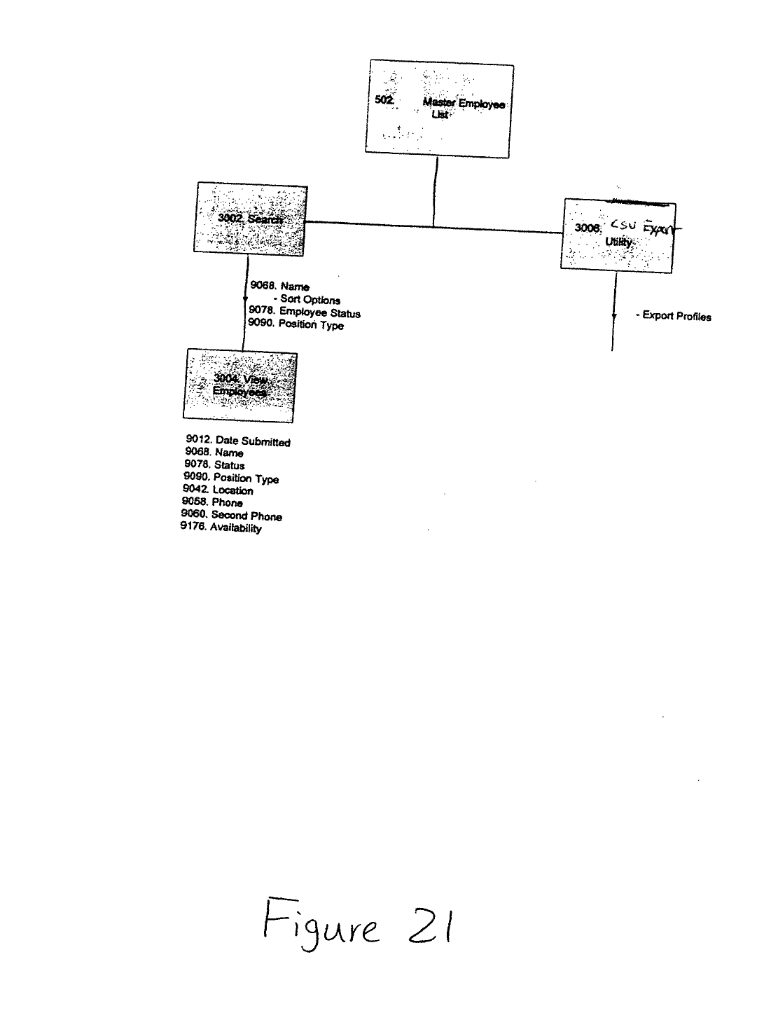

FIG. 21 shows master employee list sub-module 502 of a healthcare staffing system in accordance with one embodiment of the invention. Master employee list sub-module 502 is an employee search function that allows office staff to search for employees by name, employee status, and/or position type. Master employee list sub-module 502 includes search sub-module 3002, view employees sub-module 3004, and export utility sub-module 3006. Search sub-module 3002 allows users to search for employees using name 9068, employee status 9078, and position type 9090 search criteria. View employees sub-module 3004 allows users to view data in call list format for specified employees. The viewable data includes date submitted 9012, name 9068, status 9078, position type 9090, location 9042, phone number 9058, secondary phone number 9060, and availability 9176 (what days/shifts employee is available for work). CSV export utility 3006 allows users to create electronic export files of employee data.

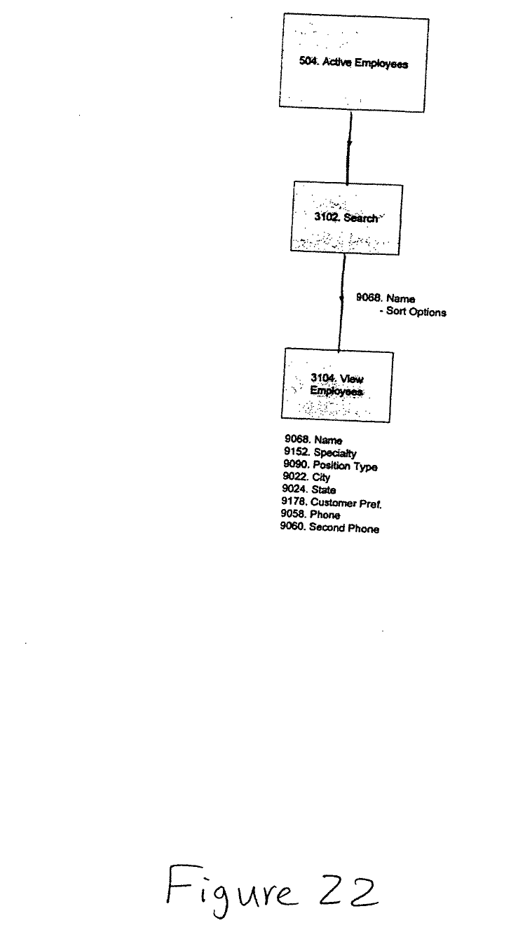

FIG. 22 shows active employees sub-module 504 of a healthcare staffing system in accordance with one embodiment of the invention. Active employees sub-module 504 allows office staff to search profiles for all employees with a status of “Active.” Active employees sub-module 504 includes search sub-module 3102 and view employees sub-module 3104. Search employees sub-module 3102 allows users to search employees with “Active” status by name 9068. View employees sub-module 3104 allows users to view data in call list format for specified employees. The viewable data includes name 9068, specialty 9152, position type 9090, city 9022, state 9024, customer preference 9178 (specifies the type of customer an employee would prefer to work for), phone number 9058, and secondary phone number 9060.

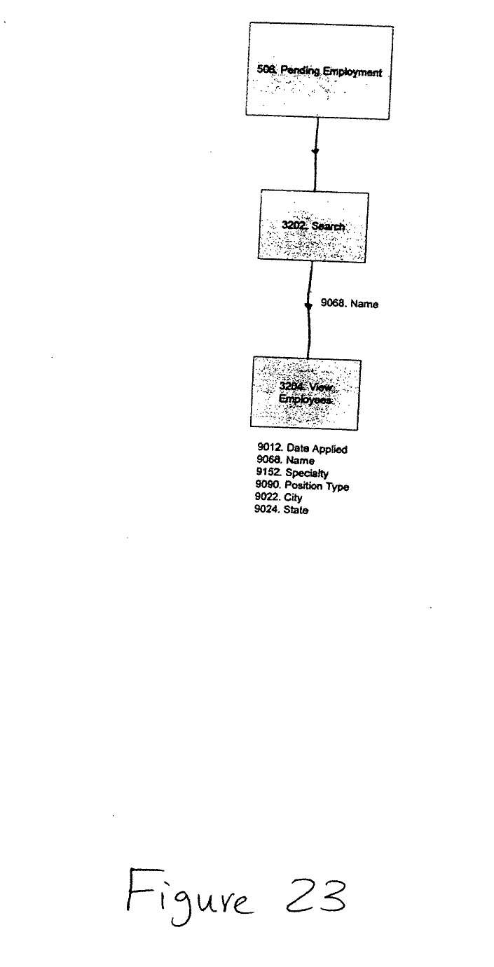

FIG. 23 shows pending employment sub-module 506 of a healthcare staffing system in accordance with one embodiment of the invention. Pending employment sub-module 506 allows office staff to search profiles for all employees with a status of “Pending.” Pending employees sub-module 506 includes search sub-module 3202 and view employees sub-module 3204. Search employees sub-module 3202 allows users to search employees with “Pending” status by name 9068. View employees sub-module 3204 allows users to view data in call list format for specified employees. The viewable data includes date applied 9012, name 9068, specialty 9152, position type 9090, city 9022, and state 9024.

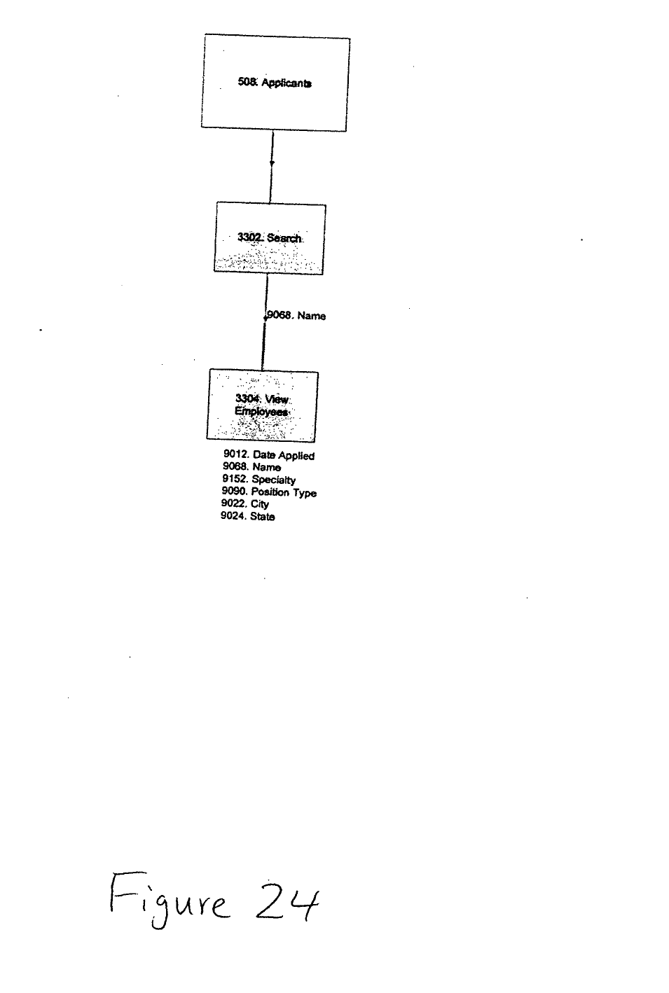

FIG. 24 shows applicants sub-module 508 of a healthcare staffing system in accordance with one embodiment of the invention. Applicants sub-module 508 allows office staff to search profiles for all employees with a status of “Applicant.” Applicants sub-module 508 includes search sub-module 3302 and view employees sub-module 3304. Search employees sub-module 3302 allows users to search applicants by name 9068. View applicants sub-module 3304 allows users to view data in call list format for specified applicants. The viewable data includes date applied 9012, name 9068, specialty 9152, position type 9090, city 9022, and state 9024.

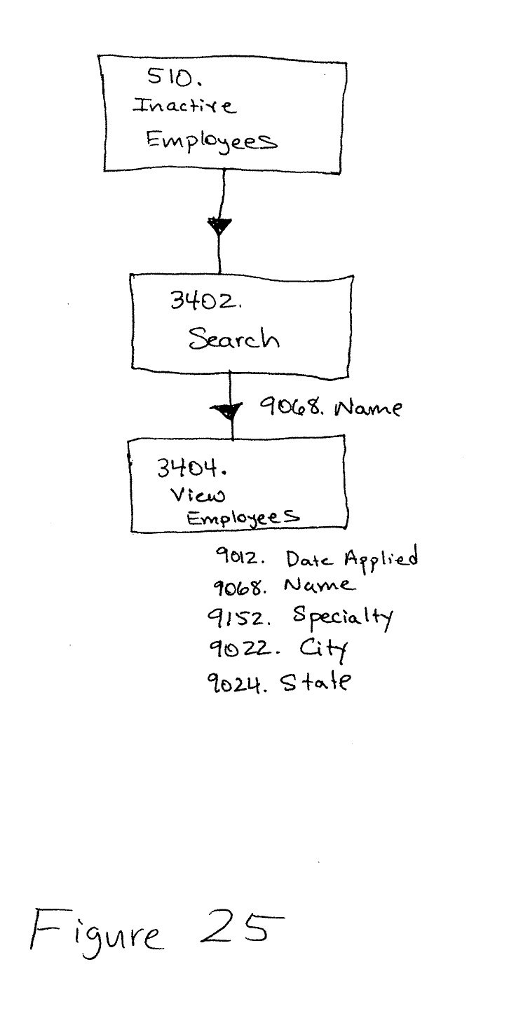

FIG. 25 shows inactive employees 510 sub-module of a healthcare staffing system in accordance with one embodiment of the invention. Inactive employees sub-module 510 allows office staff to search profiles for all employees with a status of “Inactive.” Inactive employees sub-module 510 includes search sub-module 3402 and view employees sub-module 3404. Search employees sub-module 3402 allows users to search employees with “Inactive” status by name 9068. View employees sub-module 3404 allows users to view data in call list format for specified employees. The viewable data includes date applied 9012, name 9068, specialty 9152, position type 9090, city 9022, and state 9024.

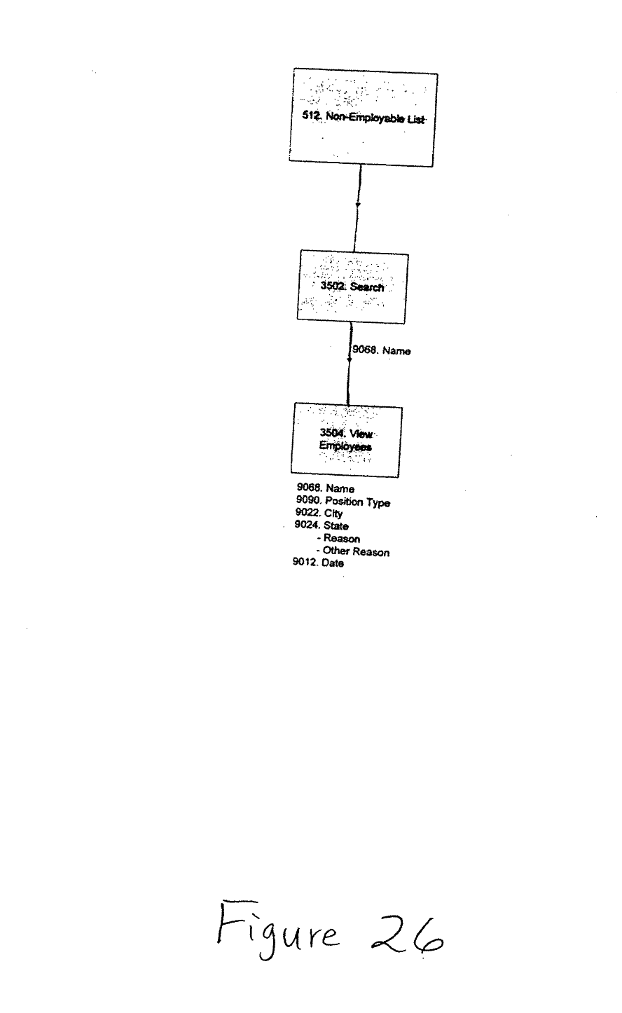

FIG. 26 shows non-employable list sub-module 512 of a healthcare staffing system in accordance with one embodiment of the invention. Non-employable list sub-module 512 allows office staff to search profiles for all employees with a status of “Unemployable.” Non-employable list sub-module 512 includes search sub-module 3502 and view employees sub-module 3504. Search employees sub-module 3502 allows users to search employees with “Unemployable” status by name 9068. View employees sub-module 3504 allows users to view data in call list format for specified employees. The viewable data includes name 9068, position type 9090, city 9022, state 9024, and date 9012. The data may also include the reason why the particular person is unemployable.

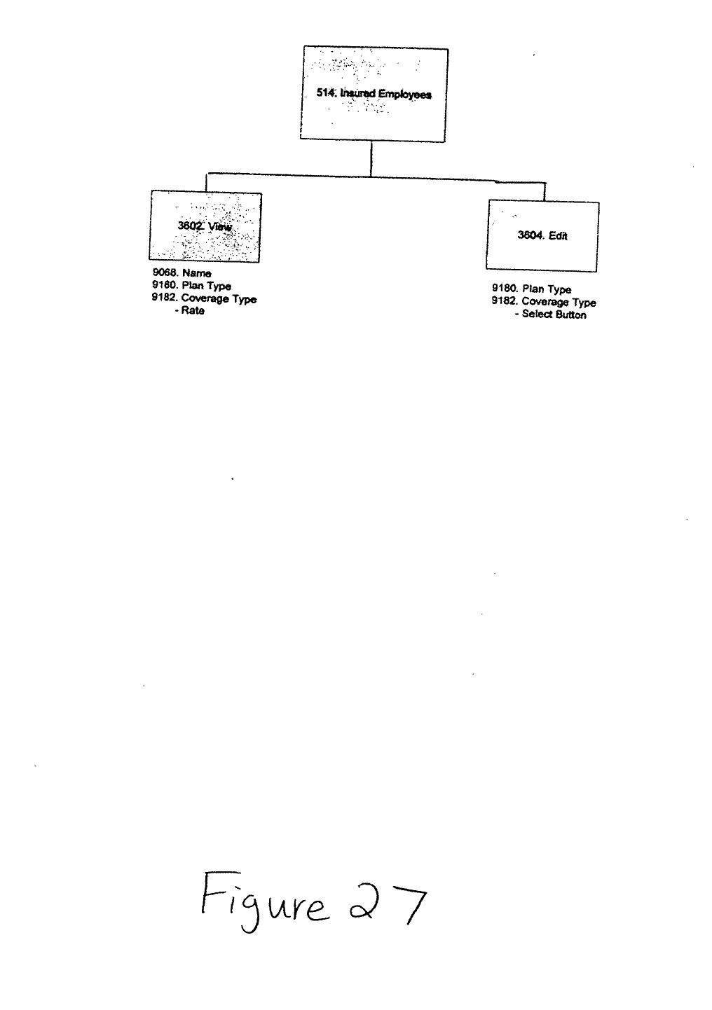

FIG. 27 shows insured employees sub-module 514 of a healthcare staffing system in accordance with one embodiment of the invention. Insured employees sub-module 514 allows users to view and update all employees who have elected insurance coverage. Insured employees sub-module 514 includes view employee sub-module 3602 and edit sub-module 3604. View sub-module 3602 allows users to view details (such as name 9068, plan type 9180, coverage type 9182, and rate) for employees who have elected insurance coverage. Edit sub-module 3604 allows user to update insurance rates by plan type 9180 and coverage type 9182.

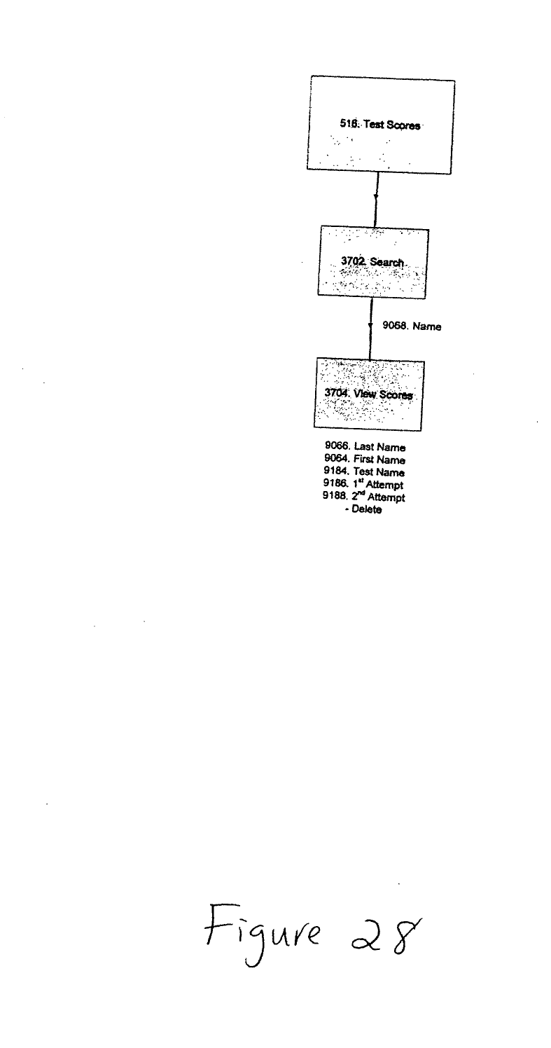

FIG. 28 shows test scores sub-module 516 of a healthcare staffing system in accordance with one embodiment of the invention. Test scores sub-module 516 allows user to view test scores for all applicable employees. Test scores sub-module 516 includes search sub-module 3702 and view scores sub-module 3704. Search sub-module 3702 allows users to search for employee test scores by name 9068. View scores sub-module 3704 displays details on test scores for selected employees. The displayed details may include last name 9066, first name 9064, test name 9184, 1^{st} attempt 9186 (test score received on first attempt), and 2^{nd} attempt 9188 (test score received on second attempt).

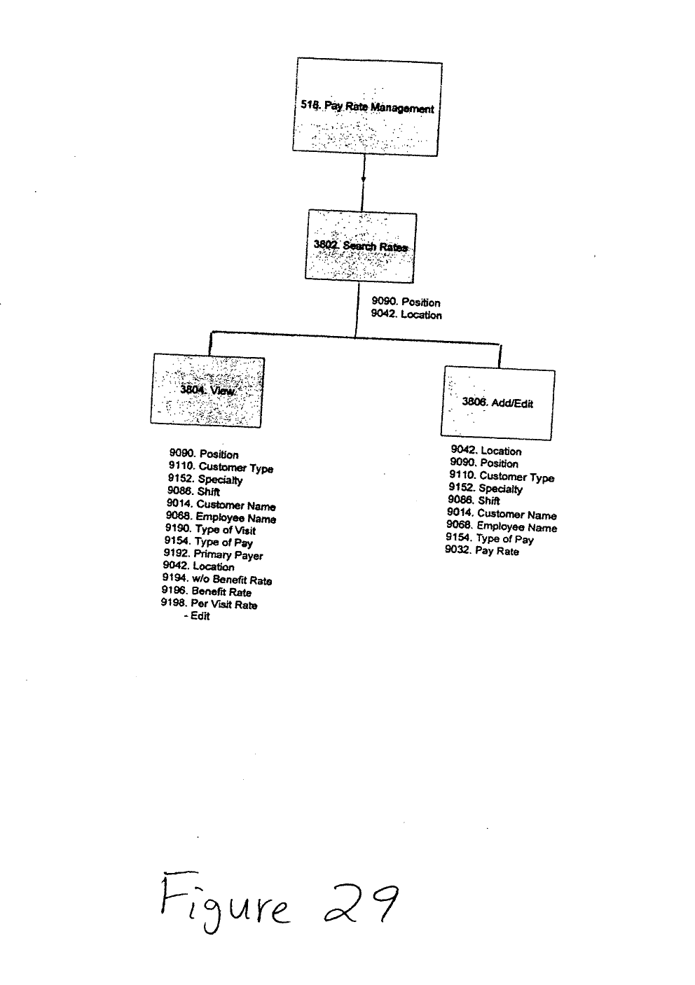

FIG. 29 shows pay rate management sub-module 518 of a healthcare staffing system in accordance with one embodiment of the invention. Pay rate management sub-module 518 allows users to set up and modify both general and employee-specific pay rates by location and position. Pay rate management sub-module 518 includes search rates sub-module 3802, view sub-module 3804, and add/edit sub-module 3806. Search rates sub-module 3802 allows users to search for pay rates by position 9090 and location 9042. View sub-module 3804 allows users to vie detailed pay rate information for the specified position/location criteria. The detailed information may include position 9090, customer type 9110, specialty 9152, shift 9086, customer name 9014, employee name 9068, type of visit 9190 (type of service required during visit), type of pay 9154, primary payer 9192 (e.g., insurance, government, individual, etc.), location 9042, without benefit rate 9194 (pay rate for employees who have not elected benefits), benefit rate 9196 (pay rate for employees who have elected benefits), and per visit rate 9198 (flat rate paid per visit). Add/edit sub-module 3806 allows users to edit or add pay rates in the system. Information that may be added or edited includes location 9042, position 9090, customer type 9110, specialty 9152, shift 9086, customer name 9014, employee name 9068, type of pay 9154, and pay rate 9032.

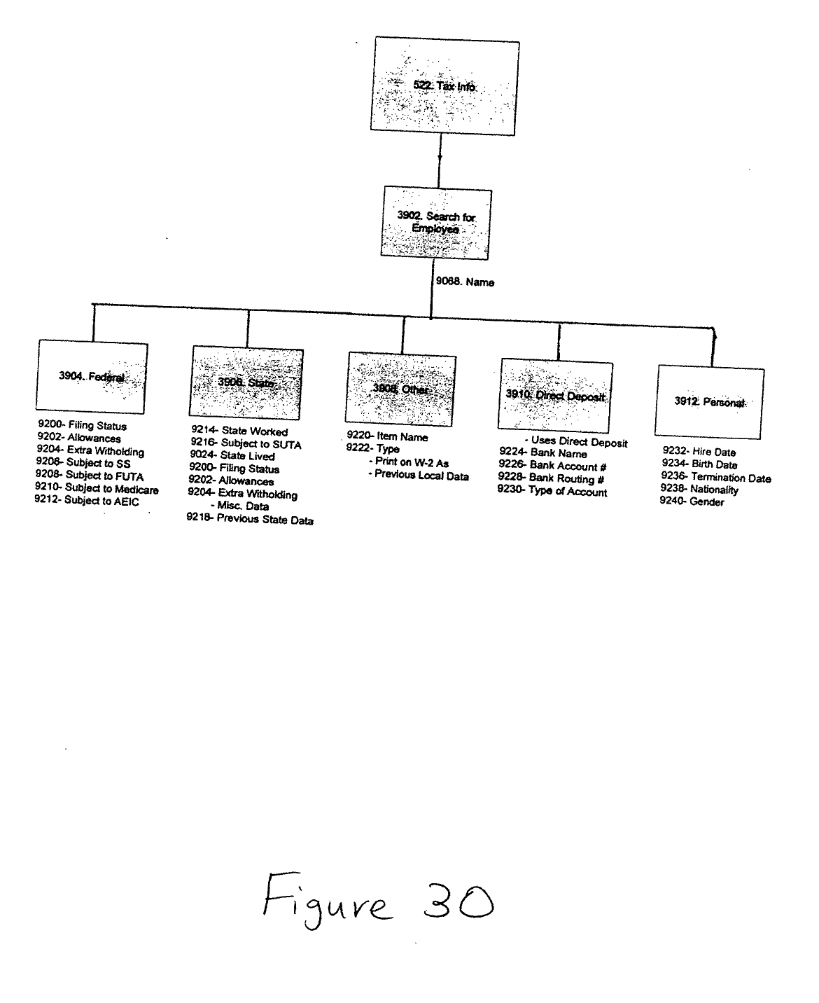

FIG. 30 shows tax info sub-module 522 of a healthcare staffing system in accordance with one embodiment of the invention. Tax info sub-module 522 allows users to input federal, state, and local tax information, direct deposit information, and personal information related to hiring and termination dates for employees. Tax info sub-module 522 includes search for employee sub-module 3902, federal sub-module 3904, state sub-module 3906, other sub-module 3908, direct deposit sub-module 3910, and personal sub-module 3912. Search for employee sub-module 3902 allows users to search for specific employee's tax information by name 9068. Federal sub-module 3904 allows users to view/update federal tax information for selected employee. The federal tax information may include filing status 9200 (single, married, etc.), allowances 9202, extra withholding 9204 (additional taxes to be withheld), subject to SS 9206 (indicates whether employee is subject to social security taxes), subject to FUTA 9208 (indicates whether employee is subject to federal unemployment taxes), subject to Medicare 9210 (indicates whether employee is subject to Medicare taxes), and subject to AEIC 9212 (indicates whether employee is subject to Advance Earned Income Credit tax). State sub-module 3906 allows users to view/update state tax information for selected employees. State tax information may include state worked 9214, subject to SUTA 9216 (indicates whether employee is subject to state unemployment taxes), state lived 9024, filing status 9200, allowances 9202, extra withholding 9204, and previous state data 9218 (indicates if employee previously worked in a different state). Other sub-module 3908 allows user to view/update other tax information for selected employees. Other tax information may include item name 9220 (name of local tax employee is subject to) and type 9222 (indicates type of addition tax/deduction employee is subject to). Direct deposit sub-module 3910 allows users to view/update direct deposit information for selected employees. Direct deposition information may include bank name 9224, bank account number 9226, bank routing number 9228, and type of account 9230 (checking, savings, etc.). Personal sub-module 3912 allows users to view/update personal information for selected employees. Personal information may include hire date 9232, birth date 9234, termination date 9236, nationality 9238, and gender 9240.

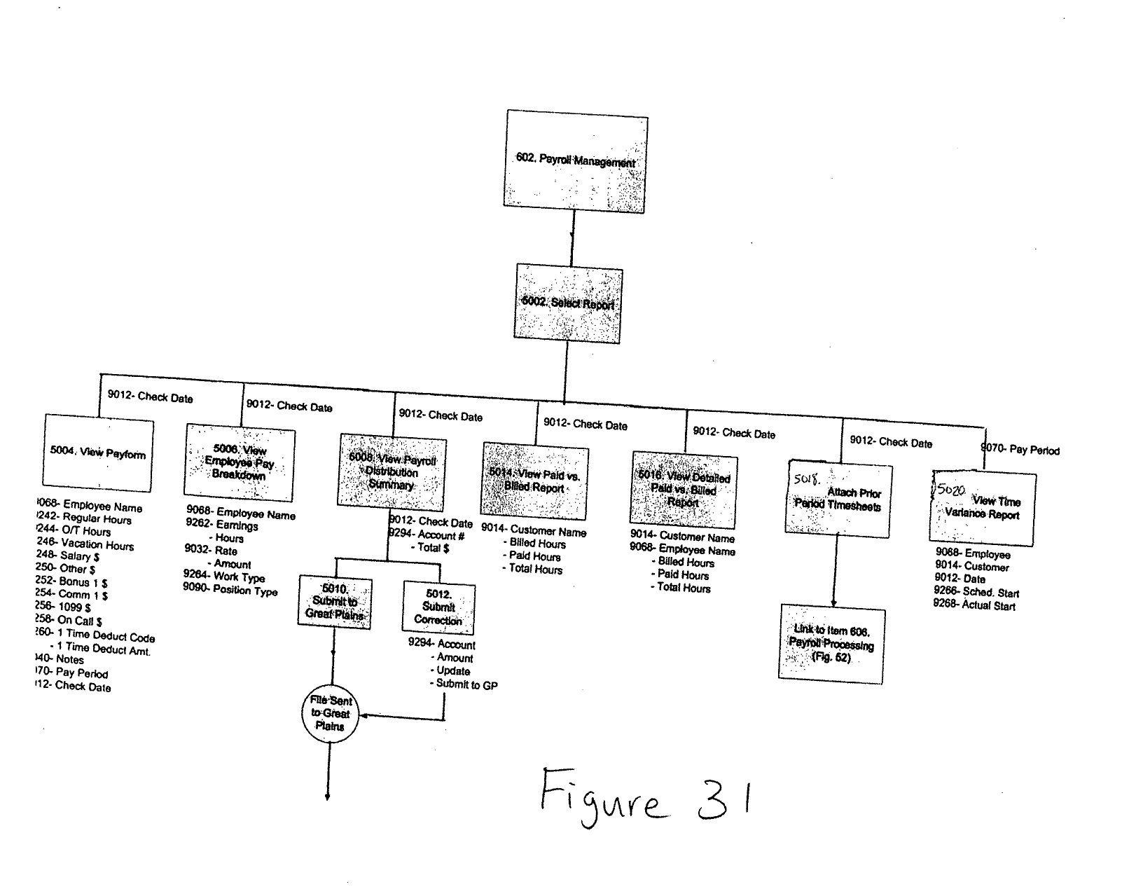

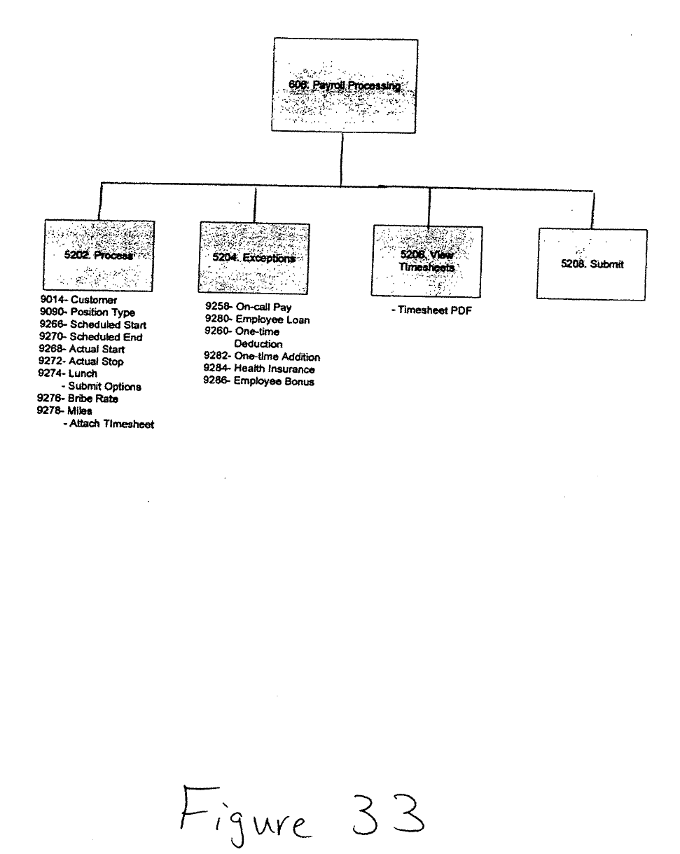

FIG. 31 shows payroll management sub-module 602 of a healthcare staffing system in accordance with one embodiment of the invention. Payroll management sub-module 602 generates payroll-related reports. Payroll management sub-module 602 includes select report sub-module 5002, view payform sub-module 5004, view employee pay breakdown 5006, view payroll distribution summary 5008, submit to Great Plains sub-module 5010, submit correction sub-module 5012, view paid vs. billed report sub-module 5014, view detail paid vs. billed report 5016, attach prior period timesheets sub-module 5018, and view time variance report sub-module 5020. Select report sub-module 5002 allows users to select and view payroll-related reports. View payform sub-module 5004 allows users to view the payform report for a selected payroll period. The report may include employee name 9068, regular hours 9242, O/T hours 9244 (overtime), vacation hours 9246, salary $ 9248 (amount of salary paid in pay period), other $ 9250 (additional taxable hours paid in pay period), bonus $ 9252 (amount of bonus paid in pay period), commission $ 9254 (amount of commission paid in pay period), 1099 $ 9256 (amount of income for pay period reportable on Form 1099), on call $ 9258 (amount of pay earned for manning on-call phone), one-time deduction 9260 (non-recurring reduction in pay for pay period), notes 9040, pay period 9070 and check date 9012. View employee pay breakdown sub-module 5006 allows user to view the employee pay breakdown report for a selected payroll period. The employee pay breakdown report may include employee name 9068, earnings 9262 (total pay for the pay period), rate 9032, work type 9264 (indicates nature of work done, such as institutional, home care, private duty, 24 hour, etc.), and position type 9090. View payroll distribution summary sub-module 5008 allows users to view the payroll distribution summary report for a selected payroll period. The payroll distribution report may include check date 9012, account number 9292 and total amount paid. Submit to Great Plains sub-module 5010 allows users to send automated payroll journal entry to Great Plains General Ledger accounting software. This sub-module can be adapted for use with other accounting software. Submit correction sub-module 5012 allows users to input correction to payroll journal entries and to send automated file to Great Plains General Ledger accounting software. Again, this sub-module may be adapted for use with other accounting software. View paid vs. billed report sub-module 5014 allows users to view the paid vs. billed report for a selected payroll period. The paid vs. billed report may include the customer name 9014, the billed hours, the paid hours, and the total hours. View detail paid v. billed report allows users to view the detail paid vs. billed report for a selected payroll period. The detail paid vs. billed report may include customer name 9014, employee name 9068, the billed hours, the paid hours, and the total hours. Attach prior period timesheets sub-module 5018 allows users to attach scanned timesheet files for a prior payroll period to specific employee records. This sub-module may be linked to payroll processing sub-module 606, which will be discussed in more detail below with reference to FIG. 33. View time variance report sub-module 5020 allows users to view time variance reports for a selected payroll period. The time variance reports may include the employee 9068, the customer 9014, the date 9012, the scheduled start 9266 (time shift was to begin), and the actual start 9268 (time shift actually started).

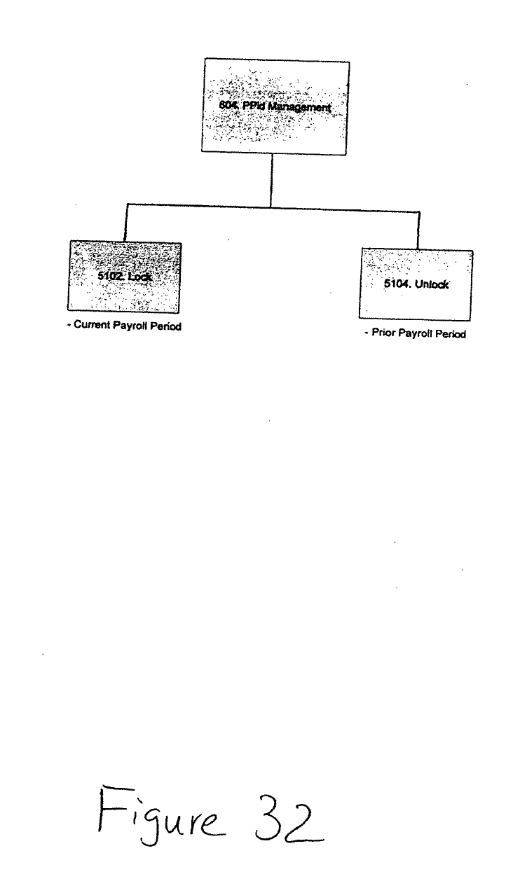

FIG. 32 shows Ppid management sub-module 604 of a healthcare staffing system in accordance with one embodiment of the invention. Ppid management sub-module 604 locks and unlocks payroll for a given payroll period. Ppid management sub-module 604 includes lock sub-module 5102 and unlock sub-module 5104. Lock sub-module 5102 locks the current payroll period so that no further changes can be made. Unlock sub-module 5104 unlocks the current pay period, allowing further updates to be made.

FIG. 33 shows payroll processing sub-module 606 of a healthcare staffing system in accordance with one embodiment of the invention. Payroll processing sub-module 606 processes weekly timesheets and payroll for all field employees. Payroll processing sub-module 606 include process sub-module 5202, exceptions sub-module 5204, view timesheets sub-module 5206, and submit sub-module 5208. Process sub-module 5202 allows users to make detailed payroll entries for employees who were schedule during the current period. The payroll entries may include customer 9014, position type 9090, scheduled start 9266, scheduled end 9270, actual start 9268, actual stop 9272, lunch 9274 (number of minutes on lunch break), bribe rate 9276 (additional hour pay per hour above standard hourly rate), and miles 9278 (number of miles submitted for reimbursement. Process sub-module 5202 may be integrated with a third-party call-in system so that employees may use a telephone to call the system and enter their actual start time, actual stop, time, and lunch time. For example, the third-party call-in system may be Jupiter Time and Attendence with the Phone Punch Add-on Module by Jantek Electronics of Temple City, CA. Exceptions sub-module 5204 allows users to enter payroll exceptions (e.g., loan repayments, mileage reimbursement, etc.) for employees. Payroll exceptions may include on-call pay 9258 (amount of pay earned for manning on-call phone), employee loan 9280 (amount of employee loan repayment deducted from pay), one-time deduction 9260 (non-recurring reduction in pay for pay period), one-time addition 9282 (non-recurring addition in pay for pay period), health insurance 9284 (amount of health insurance premium deducted from pay), and employee bonus 9286 (amount of bonus for pay period). View timesheets sub-module 5206 allows users to view scanned timesheets (e.g., in .pdf format) for employees for the current payroll period. Submit sub-module 5208 allows user to submit employee payroll information. A payroll record in generated based on hours worked and pay rate, and a corresponding billing record is created for the customer indicated.

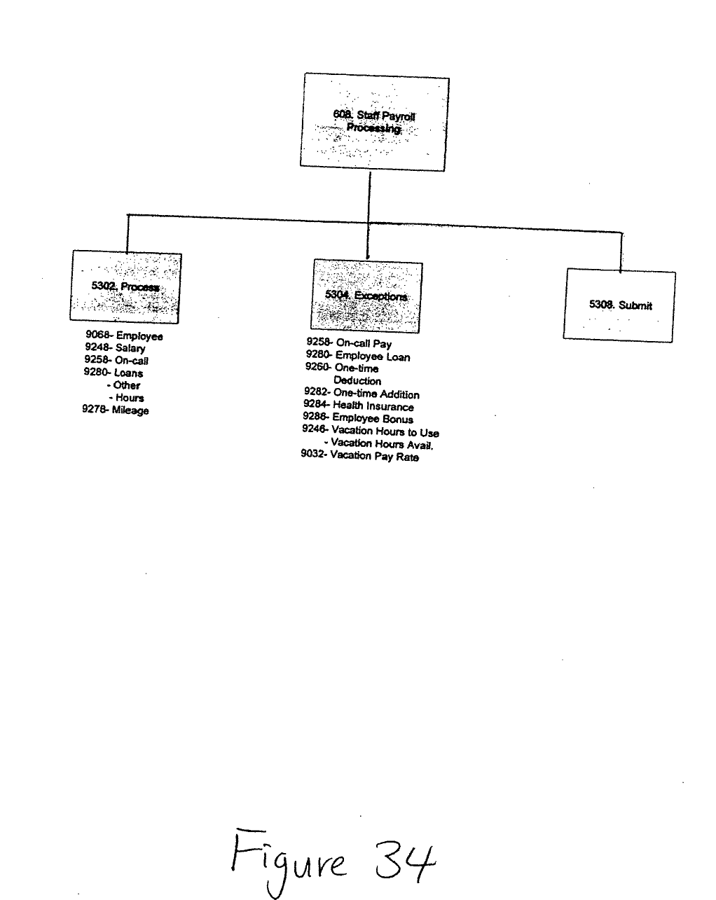

FIG. 34 shows staff payroll processing sub-module 608 of a healthcare staffing system in accordance with one embodiment of the invention. Staff payroll processing sub-module 608 processes weekly payroll for office staff. Staff payroll processing sub-module 608 includes process sub-module 5302, exceptions sub-module 5304, and submit sub-module 5308. Process sub-module 5302 allows users to process weekly payroll entries for office staff. The payroll entries may include employee 9068, salary 9248, on-call pay 9258, employee loans 9280, and mileage 9278. Exceptions sub-module 5304 allows users to enter payroll exceptions (e.g., loan repayments, on-call pay, bonus, etc.) for employees. Payroll exceptions may include on-call pay 9258, employee loans 9280, one-time deduction 9260, one-time addition 9282, health insurance 9284, employee bonus 9286, vacation hours to use 9246 (number of hours of vacation time applied in time period), and vacation pay rate 9032. Submit process 5308 allows users to submit employee pay information. Payroll records are generated based on hours worked and pay rate.

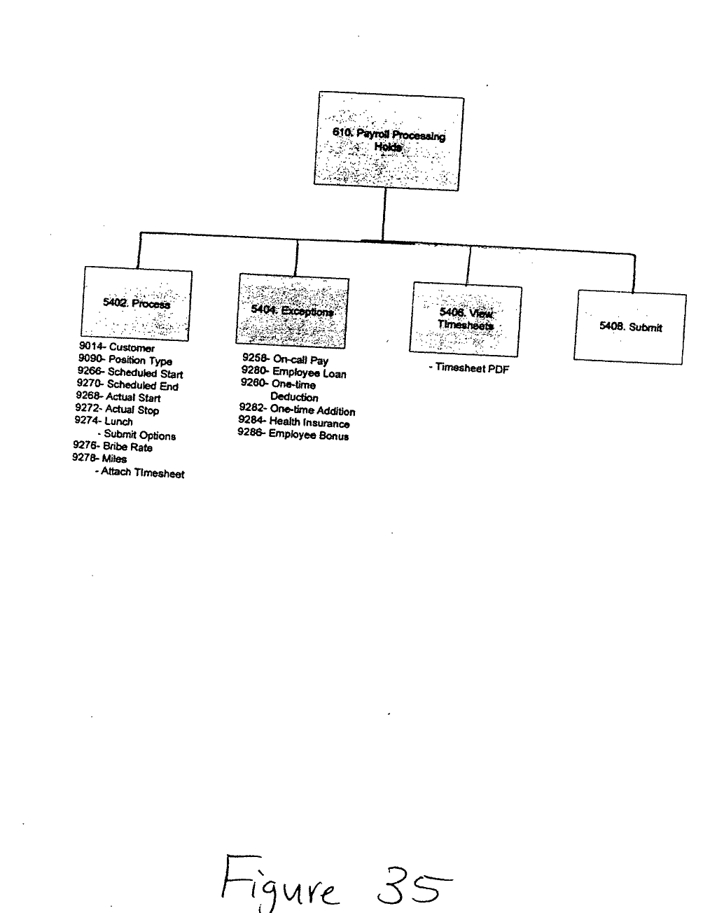

FIG. 35 shows payroll processing holds sub-module 610 of a healthcare staffing system in accordance with one embodiment of the invention. Payroll processing holds sub-module 610 processes prior period payroll amounts placed on hold due to lack of timesheets or other supporting documentations. Payroll processing holds sub-module 610 includes process sub-module 5402, exceptions sub-module 5404, view timesheets sub-module 5406, and submit sub-module 5408. Process sub-module 5402 allows users to make prior period payroll entries for employees who were not processed in the payroll period that they worked. The payroll entries may include customer 9014, position type 9090, scheduled start 9266, scheduled end 9270, actual start 9268, actual stop 9272, lunch 9274 (number of minutes on lunch break), bribe rate 9276 (additional hour pay per hour above standard hourly rate), and miles 9278 (number of miles submitted for reimbursement. Exceptions sub-module 5404 allows users to enter prior period payroll exceptions (e.g., loan repayments, mileage reimbursement, etc.) for employees. Payroll exceptions may include on-call pay 9258 (amount of pay earned for manning on-call phone), employee loan 9280 (amount of employee loan repayment deducted from pay), one-time deduction 9260 (non-recurring reduction in pay for pay period), one-time addition 9282 (non-recurring addition in pay for pay period), health insurance 9284 (amount of health insurance premium deducted from pay), and employee bonus 9286 (amount of bonus for pay period). View timesheets sub-module 5406 allows users to view scanned timesheets (e.g., in .pdf format) for employees for a prior payroll period. Submit sub-module 5408 allows user to submit employee payroll information. A payroll record in generated based on hours worked and pay rate, and a corresponding billing record is created for the customer indicated.

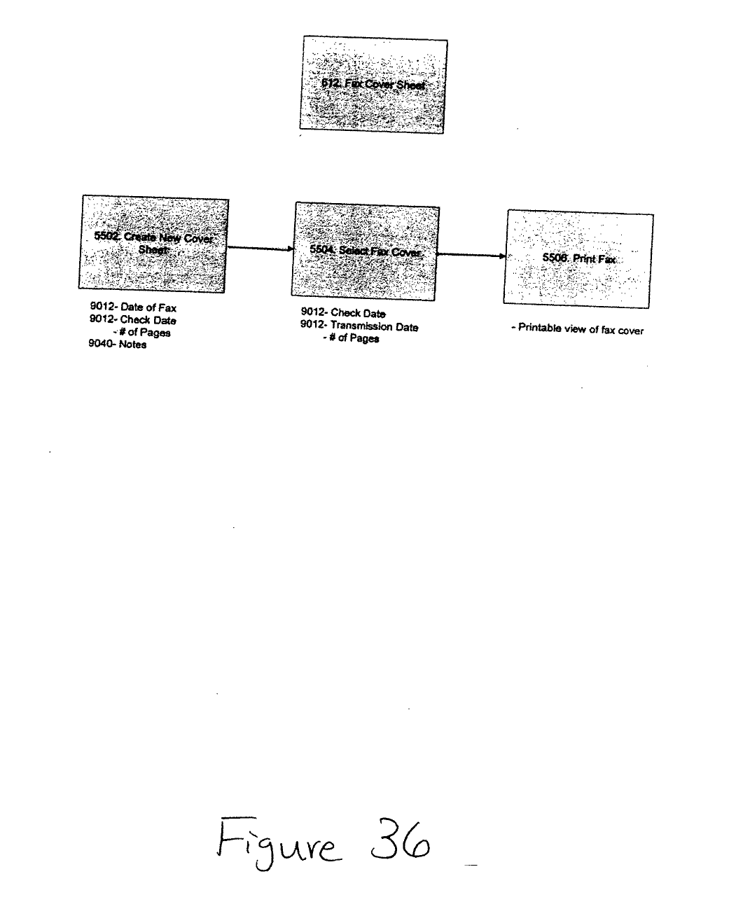

FIG. 36 shows fax cover sheet sub-module 612 of a healthcare staffing system in accordance with one embodiment of the invention. Fax cover sheet sub-module 612 generates pre-formatted cover sheet forms for faxing payroll to payroll processing. Fax cover sheet sub-module 612 includes create new cover sheet sub-module 5502, select fax cover sub-module 5504, and print fax sub-module 5506. Create new cover sheet sub-module 5502 allows users to input fax date, check date, number of pages, and comments and generates cover sheets for faxing weekly payroll to payroll processing. Select fax cover sheet sub-module 5504 allows user to view a list of fax cover sheets stored in the system and select a desired cover sheet for review and/or printing. Print fax sub-module 5506 generates a printable view of the selected fax cover sheet.

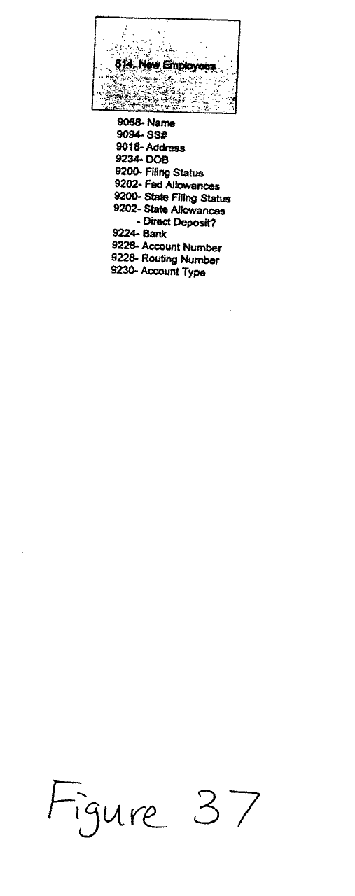

FIG. 37 shows new employees sub-module 614 of a healthcare staffing system in accordance with one embodiment of the invention. New employees sub-module 614 generates a summary page detailing payroll-related information (i.e., social security number, tax filing statuses, direct deposition information, etc.) for new employees. This information may be faxed to payroll processing with payroll. The information may include name 9068, social security number 9094, address 9018, date of birth 9234, filing status 9200 (married, single, etc.), federal allowances 9202, state filing status 9200, and state allowances 9202. If the employee has direct deposit of pay, the information may also include bank 9224, account number 9226, routing number 9228, and account type 9230.

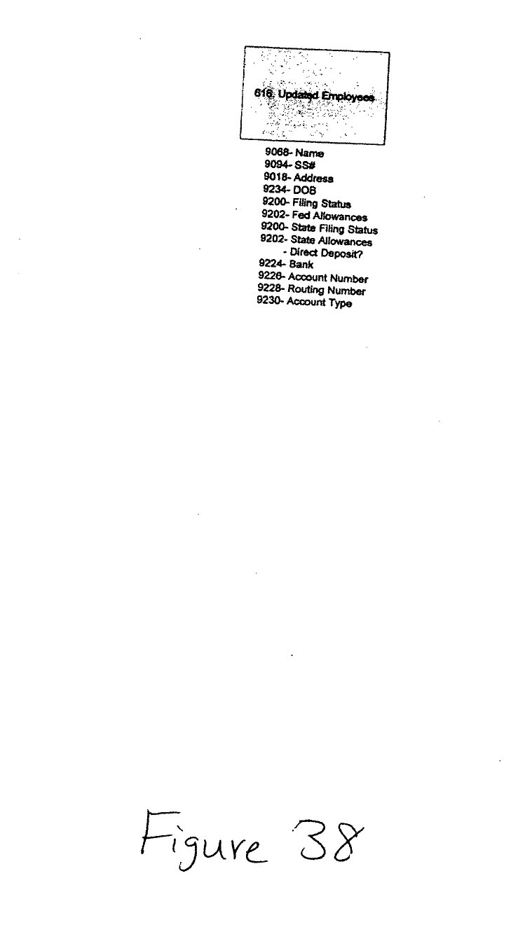

FIG. 38 shows updated employees sub-module 616 of a healthcare staffing system in accordance with one embodiment of the invention. Updated employees sub-module 616 generates a summary page detailing changes to payroll-related information (i.e., social security number, tax filing statuses, direct deposition information, etc.) for existing employees. This information may be faxed to payroll processing with payroll. The payroll-related information may include name 9068, social security number 9094, address 9018, date of birth 9234, filing status 9200, federal allowances 9202, state filing status 9200, state allowances 9202. If the employee has direct deposit of pay, the information may also include bank 9224, account number 9226, routing number 9228, and account type 9230.

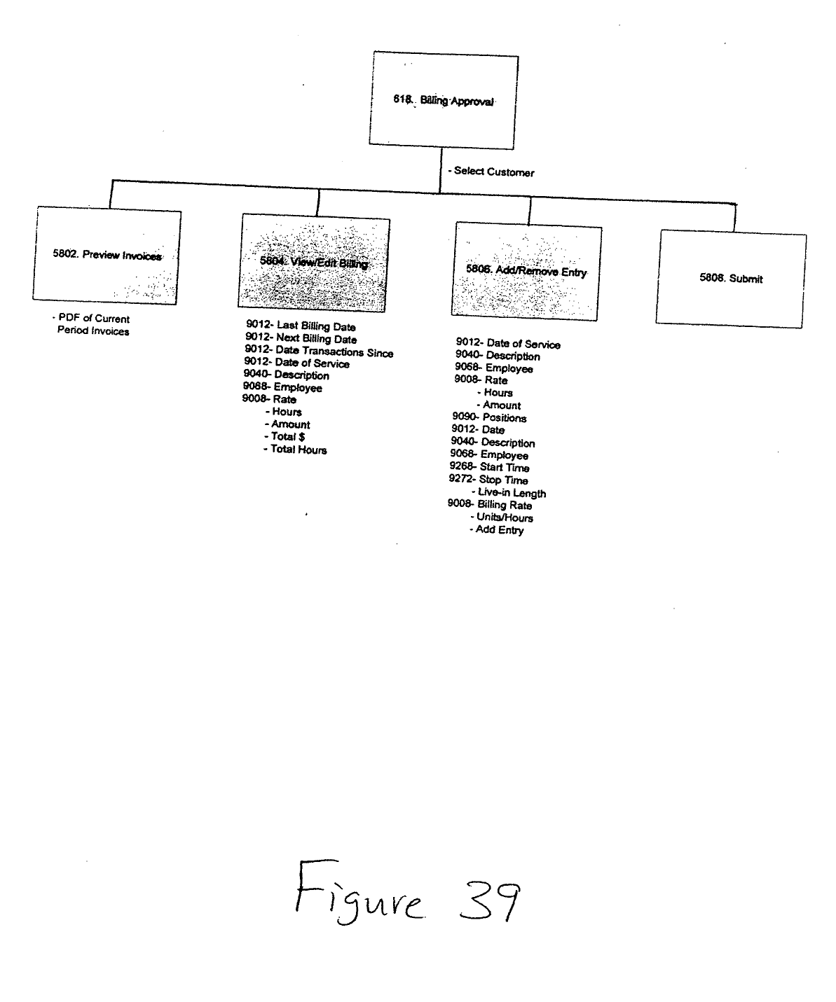

FIG. 39 shows billing approval sub-module 618 of a healthcare staffing system in accordance with one embodiment of the invention. Billing approval sub-module 618 allows users to review, revise, and approve weekly invoices. Billing approval sub-module 618 includes preview invoices. Billing approval sub-module 618 includes preview invoice sub-module 5802, view/edit billing sub-module 5804, add/remove entry sub-module 5806, and submit sub-module 5808. Preview invoices sub-module 5802 allows users to preview a .pdf of the current week's invoices for a selected customer. View/edit billing sub-module 5804 allows users to view and/or edit line item details on the current week's invoice for a selected customer. The line item details may include last billing date 9012, next billing date 9012, date of transaction, date of service, description 9040, employee name 9068, and rate 9008 (may also include hours, amount, total pay, and total hours). Add/remove entry sub-module 5806 allows users to add new billing line items or delete existing line items. Examples of line items that may be added or deleted include date of service 9012, description 9040, employee name 9068, rate 9008, position 9090, start time 9268, and stop time 9272. Submit sub-module 5808 generates online invoices with associated timesheets and send sales entries to an accounting program, such as Great Plains General Ledger 116.

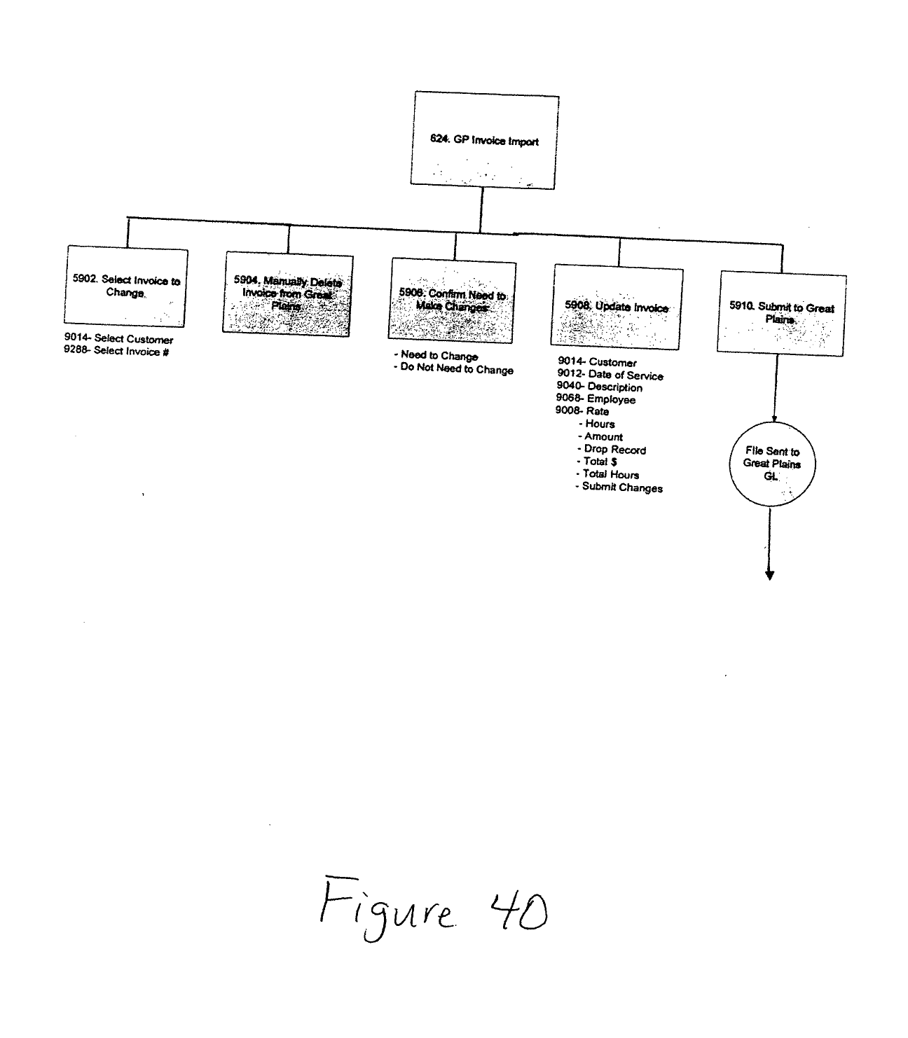

FIG. 40 shows GP invoice import sub-module 624 of a healthcare staffing system in accordance with one embodiment of the invention. GP invoice import sub-module 624 allows users to import prior period's invoice back from an external accounting program. Users many then adjust invoices as necessary and resubmit them to the external accounting program. GP invoice import sub-module 624 includes select invoice to charge sub-module 5902, manually delete invoice from Great Plains sub-module 5904, confirm need to make changes sub-module 5906, update invoice sub-module 5908, and submit to Great Plains sub-module 5910. The GP Invoice Import sub-module and other associated sub-modules are described as interfacing with the Great Plains General Ledger accounting program, however, they may be adapted to interface with any accounting program. Select invoice to charge sub-module 5902 allows users to select which invoice entry they wish to import back from Great Plains. Manually delete invoice from Great Plains sub-module 5904 generates a warning reminding users to delete original invoices in Great Plains to avoid duplicate entries. Confirm need to make changes sub-module 5096 asks users to confirm that they want to import and change an existing Great Plains invoice entry. Update invoice sub-module 5908 displays line item details for imported invoice entries and allows users to update key fields. The line items displayed and key fields updatable include customer 9014, date of service 9012, description 9040, employee, 9068, and rate 9008. Other information may be displayed including hours, amount, drop record, total paid, and total hours. Submit to Great Plains sub-module 5910 sends revised invoice entries back to Great Plains for posting.

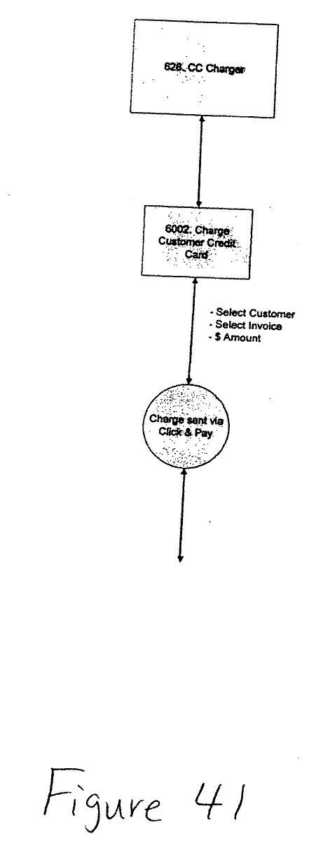

FIG. 41 shows credit card charger sub-module 626 of a healthcare staffing system in accordance with one embodiment of the invention. Credit card charger sub-module 626 charges credit cards for services and associate payment with a specific customer/invoice number. Credit card charger sub-module 626 includes charge credit customer credit card sub-module 6002. Charge customer credit card sub-module 6002 allows users to select customer and invoice numbers, input dollar amounts, and charge a customer's credit card of record. A Great Plains entry may be generated that associates payment with the invoice number selected. In addition, the invoice may be sent via an online 3rd party credit card processing system.

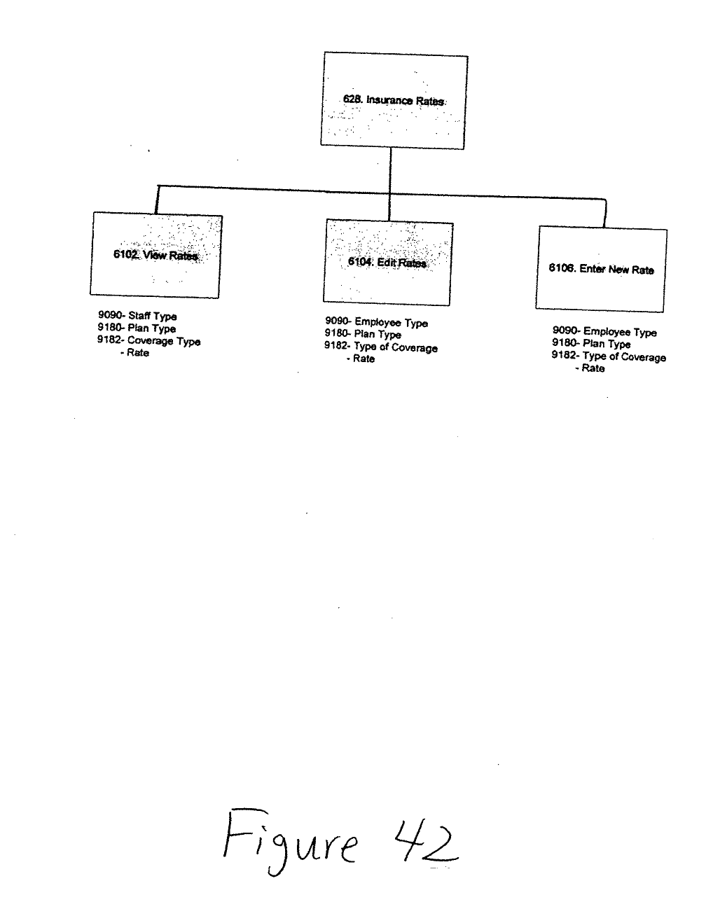

FIG. 42 shows insurance rates sub-module 628 of a healthcare staffing system in accordance with one embodiment of the invention. Insurance rates sub-module 628 allows users to view and update health insurance rates by plan type and coverage type for field and office staff. Insurance rates sub-module 628 includes view rates sub-module 6102, edit rates sub-module 6104, and enter new rate sub-module 6106. View rates sub-module 6102 allows users to view health insurance rates for office and field staff by plan type and coverage type. The information viewable may include staff type 9090, plan type 9180, coverage type 9182, and the rate. Edit rates sub-module 6104 allows users to update health insurance rates for office and field staff by plan type and coverage type. Enter new rate sub-module 6106 allows user to set up new health insurance rates for office and field staff. The information entered to set up new health insurance rates may include employee type 9090 (field or office staff), plan type 9180, type of cover 9182, and rate.

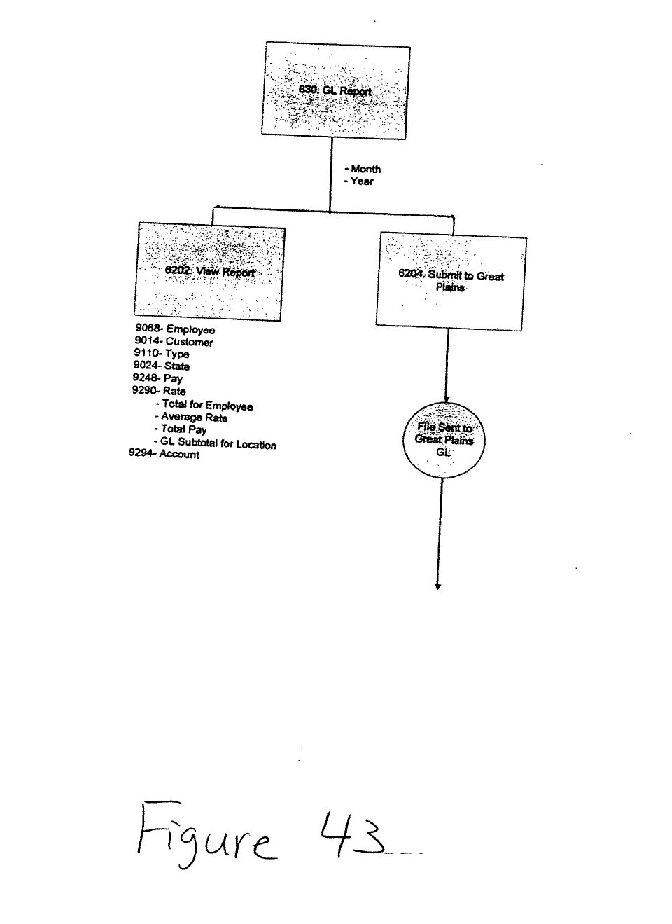

FIG. 43 shows GL report sub-module 630 of a healthcare staffing system in accordance with one embodiment of the invention. GL report sub-module 630 allows users to detail supporting monthly GL insurance expenses by account and submits a journal entry to an external accounting program. GL report sub-module 630 includes view report sub-module 6202 and submit to Great Plains sub-module 6204. View report sub-module 6202 allows users to view a report of general liability premiums owed by the employee/customer. Information in the report may include employee name 9068, customer 9014, type 9110, state 9024, pay 9248, rate 9290 (which may include total for employee, average rate, total pay, GL subtotal for location), and account number 9294. Submit to Great Plains sub-module 6204 sends an insurance entry to Great Plains for posting. The GL report sub-module may also be adapted to send entries to other accounting programs.

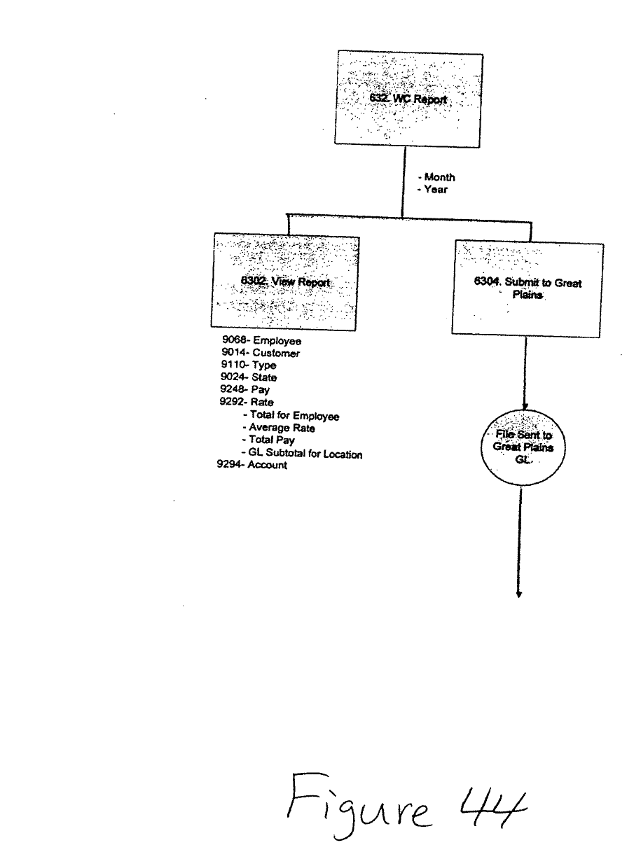

FIG. 44 shows WC report sub-module 632 of a healthcare staffing system in accordance with one embodiment of the invention. WC report sub-module 632 allows users to view detail supporting monthly WC insurance expenses by account and submits a journal entry to an external accounting program. WC report sub-module 632 includes view report sub-module 6302 and submit to Great Plains sub-module 6304. View report sub-module 6302 allows users to view a report of worker's compensation insurance premiums owed by the employee/customer. Information in the report may include employee name 9068, customer 9014, type 9110, state 9024, pay 9248, rate 9290 (which may include total for employee, average rate, total pay, WC subtotal for location), and account number 9294. Submit to Great Plains sub-module 6304 sends an insurance entry to Great Plains for posting. The WC report sub-module may also be adapted to send entries to other accounting programs.

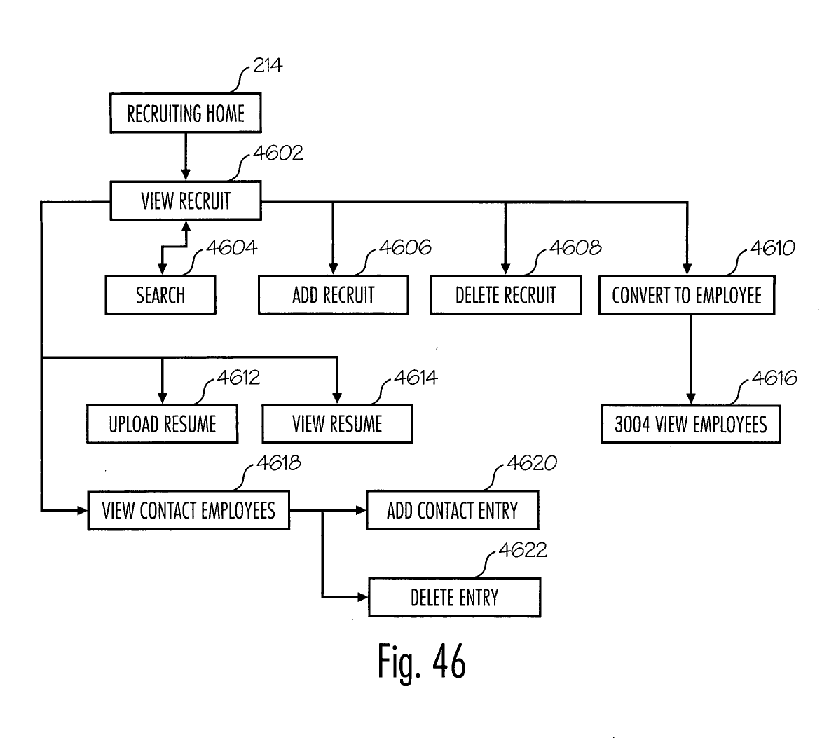

FIG. 46 shows recruiting module 214 of a healthcare staffing system in accordance with one embodiment of the invention. Recruiting module 214 assists users in managing all functions of the recruiting process including lead generation, contact maintenance, scheduling and tracking follow-up. Recruiting module 214 includes search sub-module 4604, view recruit sub-module 4602, add recruit sub-module 4606, delete recruit sub-module 4608, convert to employee sub-module 4610, upload resume sub-module 4612, view resume sub-module 4614, view contact history sub-module 4618, add contact entry sub-module 4620, and delete entry sub-module 4622. Search sub-module 4604 allows users to search for an existing recruit in order to review or add information. The user may search by any of first name, last name, email address, city, zip code, radius from zip code, school, phone number, position, source, contact type, recruiter, and contact dates. View recruit sub-module 4602 allows users to view or edit recruit information. Information that may be viewed or edited includes first name, last name, active flag, address, city, state, zip code, license number, phone number, alternate phone number, email address, fax number, location, positions, school, degree, previous employer 1, previous employer 2, previous employer 3, referral, additional skills, and resume. Add recruit sub-module 4606 allows users to add a new recruit record in the system. The information that may be recorded is identical to the information that may be viewed or edited in view recruit sub-module 4602. Delete recruit sub-module 4608 allows users to remove the currently viewed recruit record from the system. Convert to employee sub-module 4610 allows users to transform the currently viewed recruit record into an employee record of employee module 206. Upload resume sub-module 4612 allows users to store an electronic resume of any format with the recruit's record. View resume sub-module 4614 allows users to view on their computer screen the complete resume of a recruit that was previously uploaded. View contact history sub-module 4618 allows users to review contact or attempted contact between the recruit and the user. Information that may be reviewed includes contact date, contact type, next action, and notes. Add contact entry sub-module 4620 allows users to create a new record of contact between the recruit and the user. Information that may be recorded includes contact date, contact type, next action, and notes. Delete entry sub-module 4622 allows users to remove a record of contact between the recruit and the user.

Other embodiments of the invention will be apparent to those skilled in the art from consideration of the specification and embodiments disclosed herein. Thus, the specification and examples are exemplary only, with the true scope and spirit of the invention set forth in the following claims and legal equivalents thereof.

What is claimed is:

1. A staffing system comprising:
interconnected processor, input devices, output devices, permanent storage memory, working memory, and communication interface components operating as a computer system;
a program instruction resident in said interconnected processor, permanent storage memory and working memory of said computer system,
wherein the program instruction includes a sales module for scheduling field employees in both professional and in-home settings.

2. The staffing system according to claim 1 wherein the program instruction further includes a customer module for bill rate management, and account setup/maintenance.

3. The staffing system according to claim 2 wherein the program instruction further includes an administration module for generating corporate announcements, printing pay stubs, and managing system users.

4. The staffing system according to claim 2 wherein the program instruction further includes an employee module for applicant setup and maintenance and pay rate management.

5. The staffing system according to claim 2 wherein the program instruction further includes a financial module for payroll maintenance, billing, financial reconciliations, insurance management, and interfacing with external accounting programs.

6. The staffing system according to claim 2 wherein the program instruction further includes a workflow queue module for managing day-to-day workflows and tasks and for displaying scripting for customer and employee interactions.

7. The staffing system according to claim 2 wherein the program instruction further includes:
an administration module for generating corporate announcements, printing pay stubs, and managing system users;
an employee module for applicant setup and maintenance and pay rate management;
a financial module for payroll maintenance, billing, financial reconciliations, insurance management, and interfacing with external accounting programs;
a recruiting module for lead generation, contact maintenance, scheduling and tracking follow-up; and
a workflow queue module for managing day-to-day workflows and tasks and for displaying scripting for customer and employee interactions.

8. The healthcare staffing system of claim 1 wherein the sales module allows for scheduling by client type, department and shift, populates pay rate per employee, and calculates bill rate per client.

9. The healthcare staffing system of claim 5 wherein the financial module is integrated with a telephone call-in program which allows for users to phone in start and stop times of their shift, the start and stop times being automatically entered into the timesheet for the user by the financial module.

10. The healthcare staffing system of claim 4 wherein the employee module allows for online employment application, tests, and continuing education.

11. The healthcare staffing system of claim 4 wherein the employee module allows users to view employee handbooks, schedules, pay stubs and to print timesheets.

12. The healthcare staffing system of claim 5 wherein the financial module prevents future scheduling for clients on credit hold.

13. The healthcare staffing system of claim 5 wherein the financial module generates reports of hours billed by location and reports of revenue and gross profit by client an position time.

14. The healthcare staffing system of claim 5 wherein the financial module includes a cash flow projection tool.

15. The healthcare staffing system of claim 5 wherein the financial module includes a pricing model tool to ensure bill rates meet minimum margin criteria.

16. The healthcare staffing system of claim 1 including centralized for all human resource documents including but not limited to: job descriptions, interview guidelines, termination procedures and exit check list, tests and checklist by position type, HIPAA and blood borne pathogen (BBP) training, compliance forms, new hire checklist and orientation materials.

17. The healthcare staffing system of claim 4 wherein the employee module allows a user to set bill rates and pay rate variances, to a set amount per hour by position type, and to route new bill rates for pre-approval.

18. The healthcare staffing system of claim 3 wherein the administration module generates online job postings, newsletters, and announcements.

19. The healthcare staffing system of claim 5 wherein the financial module automatically sends worker's compensation and professional/general liability insurances expenses to an accounting program.

20. The healthcare staffing system of claim 1 wherein the sales module further assists in lead generation, contact maintenance, and tracking follow-up.

21. The healthcare staffing system of claim 20 wherein the sales module allows a user to load client prospect lists and send periodic communication by client type.
